(19) United States
(12) Patent Application Publication
(10) Pub. No.: US 2019/0386574 A1
(43) Pub. Date: Dec. 19, 2019

(54) POWER SUPPLY AND POWER SUPPLY UNIT

(71) Applicant: SHARP KABUSHIKI KAISHA, Sakai City, Osaka (JP)

(72) Inventors: TAKESHI SHIOMI, Sakai City, Osaka (JP); AKIHIDE SHIBATA, Sakai City, Osaka (JP); HIROSHI IWATA, Sakai City, Osaka (JP)

(73) Assignee: SHARP KABUSHIKI KAISHA, Sakai City, Osaka (JP)

(21) Appl. No.: 16/487,732

(22) PCT Filed: Jan. 29, 2018
(86) PCT No.: PCT/JP2018/002616

§ 371 Date: Aug. 21, 2019

(30) Foreign Application Priority Data
Feb. 23, 2017 (JP) 2017-031950

(51) Int. Cl. H02M 3/335

(52) U.S. Cl. CPC H02M 3/33592; H02M 3/33507

(57) ABSTRACT

A power supply includes a transformer including a primary winding and a plurality of secondary windings, a primary circuit connected to the primary winding; and a plurality of secondary circuits connected to the plurality of secondary windings, respectively. The secondary circuit performs a power regeneration operation of transmitting power to the primary circuit or the secondary circuit. The secondary circuit includes MOSFETs configured to rectify the power transmitted from a primary side of the transformer and a capacitor configured to store the power that is rectified and is configured to perform a discharge operation of discharging the capacitor and causing a current to flow into a secondary winding of the plurality of secondary windings of the transformer. Thus, the power supply capable of stably outputting a plurality of voltages and having a high power-conversion efficiency is provided.

### TECHNICAL FIELD

The disclosure relates to a power supply and a power supply unit including the power supply.

### BACKGROUND ART

As a power supply that outputs direct current (DC) voltage, an isolated DC/DC converter is widely used. Further, as a power supply including a plurality of outputs, there is known a power supply provided with a single switching circuit on a primary side of a transformer and with a plurality of rectifier circuits on a secondary side of the transformer. By providing a plurality of rectifier circuits correspondingly to a single switching circuit, it is possible to make the power supply including the plurality of outputs smaller and lower in cost.

PTL 1 describes a power supply configured to synchronize a sub-output with a main output using a simple configuration and supply a stable output to a load (refer to FIG. 38). In the power supply illustrated in FIG. 38, a switching element Qy is connected to a secondary winding Sy of a transformer TRx. A pulse output of the secondary winding Sy is supplied to the load after being smoothed by the switching element Qy. A comparator CMP2 is provided as a Pulse Width Modulation (PWM) control circuit, is configured to compare a triangular signal, obtained by integrating the pulse output of a secondary winding Sx by an integration circuit IG1, with a result of detecting an output voltage from the secondary winding Sy by a detection circuit DT2, and is configured to control a conduction angle of the switching elements Qy in accordance with the result.

### CITATION LIST

### Patent Literature

PTL 1: JP H07-194114 A

### SUMMARY

### Technical Problem

However, in the power supply illustrated in FIG. 38, a current resulting from an electromotive force generated in the secondary winding Sy of the transformer TRx flows to the load after passing through two elements (a rectifying diode Dz and the switching element Qy). As a result, the problem arises that the power supply illustrated in FIG. 38 exhibits significant conduction loss.

Accordingly, providing a power supply capable of stably outputting a plurality of voltages and having a high power-conversion efficiency has become an issue.

### Solution to Problem

The above-described problems can be solved by a power supply including, for example, a transformer including a primary winding and a plurality of secondary windings, a switching circuit connected to the primary winding, and a plurality of rectifier circuits connected to the plurality of secondary windings, respectively. At least one of the plurality of rectifier circuits is configured to perform a power regeneration operation of transmitting power to the switching circuit or another rectifier circuit of the plurality of rectifier circuits.

### Advantage Effects of Disclosure

According to the power supply described above, the rectifier circuit having a small output power performs a power regeneration operation, causing power to be transmitted from the rectifier circuit having a small output power to the switching circuit or another rectifier circuit. This makes it possible to prevent an excessive increase in output voltage in the rectifier circuit having a small output power. Accordingly, it is possible to provide a power supply capable of stably outputting a plurality of voltages.

### BRIEF DESCRIPTION OF DRAWINGS

FIG. 1 is a circuit diagram of a power supply according to a first reference example.

FIG. 2 is a timing chart of the power supply illustrated in FIG. 1.

FIG. 3 is a diagram illustrating a portion of the timing chart illustrated in FIG. 2 in detail.

FIG. 4 is a current path diagram of a period T11 of the power supply illustrated in FIG. 1.

FIG. 5 is a current path diagram of a first half of a period T12 of the power supply illustrated in FIG. 1.

FIG. 6 is a current path diagram of a second half of the period T12 of the power supply illustrated in FIG. 1.

FIG. 7 is a current path diagram of a first half of a period T13 of the power supply illustrated in FIG. 1.

FIG. 8 is a current path diagram of a second half of the period T13 of the power supply illustrated in FIG. 1.

FIG. 9 is a current path diagram of a period T141 of the power supply illustrated in FIG. 1.

FIG. 10 is a current path diagram of a start of a period T142 of the power supply illustrated in FIG. 1.

FIG. 11 is a current path diagram of a first half of a period T143 of the power supply illustrated in FIG. 1.

FIG. 12 is a current path diagram of a second half of the period T143 of the power supply illustrated in FIG. 1.

FIG. 13 is a current path diagram of a period T15 of the power supply illustrated in FIG. 1.

FIG. 14 is a circuit diagram of a power supply according to a first embodiment.

FIG. 15 is a circuit diagram of a primary circuit of a power supply according to a modified example of the first embodiment.

FIG. 16 is a circuit diagram of a power supply according to a second reference example.

FIG. 17 is a timing chart of the power supply illustrated in FIG. 16.

FIG. 18 is a diagram illustrating a portion of the timing chart illustrated in FIG. 17 in detail.

FIG. 19 is a current path diagram of the period T11 of the power supply illustrated in FIG. 16.

FIG. 20 is a current path diagram of the first half of the period T12 of the power supply illustrated in FIG. 16.

FIG. 21 is a current path diagram of the second half of the period T13 of the power supply illustrated in FIG. 16.

FIG. 22 is a current path diagram of the period T141 of the power supply illustrated in FIG. 16.

FIG. 23 is a current path diagram of the start of the period T142 of the power supply illustrated in FIG. 16.

FIG. 24 is a current path diagram of the first half of the period T143 of the power supply illustrated in FIG. 16.

FIG. 25 is a current path diagram of the second half of the period T143 of the power supply illustrated in FIG. 16.

FIG. 26 is a circuit diagram of a power supply according to a second embodiment.

FIG. 27 is a circuit diagram of a power supply according to a third reference example.

FIG. 28 is a timing chart of the power supply illustrated in FIG. 27.

FIG. 29 is a current path diagram of a first half of a period T21 of the power supply illustrated in FIG. 27.

FIG. 30 is a current path diagram of a period T231 of the power supply illustrated in FIG. 27.

FIG. 31 is a current path diagram of a period T232 of the power supply illustrated in FIG. 27.

FIG. 32 is a current path diagram of a period T24 of the power supply illustrated in FIG. 27.

FIG. 33 is a current path diagram of a period T25 of the power supply illustrated in FIG. 27.

FIG. 34 is a current path diagram of a first half of a period T26 of the power supply illustrated in FIG. 27.

FIG. 35 is a current path diagram of a second half of the period T26 of the power supply illustrated in FIG. 27.

FIG. 36 is a circuit diagram of a power supply according to a third embodiment.

FIG. 37 is a block diagram of a power supply unit according to a fourth embodiment.

FIG. 38 is a circuit diagram of a known power supply.

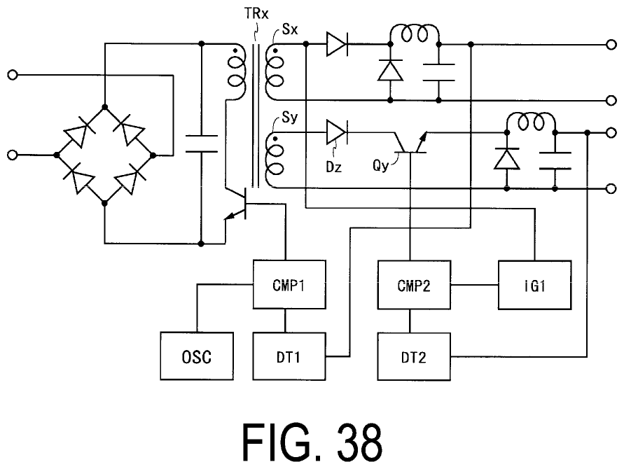

### DESCRIPTION OF EMBODIMENTS

A power supply according to embodiments will be described hereinafter with reference to the drawings. The power supply according to each embodiment includes a transformer including a primary winding and a plurality of secondary windings, a switching circuit connected to the primary winding, and a plurality of rectifier circuits connected to the plurality of secondary windings, respectively. In the power supply according to each embodiment, at least one of the rectifier circuits is configured to perform a power regeneration operation of transmitting power to the switching circuit or another rectifier circuit. Further, at least one of the plurality of rectifier circuits includes a rectifier element configured to rectify the power transmitted from a primary side of the transformer, a capacitor configured to accumulate the power that is rectified and is configured to perform a discharge operation of discharging the capacitor and causing a current to flow into a secondary winding of the plurality of secondary windings of the transformer.

In a power supply including one switching circuit and a plurality of rectifier circuits, the one switching circuit corresponds to a plurality of outputs. As a result, in a case that the plurality of outputs include an output having a large output power and an output having a small output power, the output voltage corresponding to the small output power may rise more than necessary. Hereinafter, this phenomenon is referred to as “excessive rise in output voltage”.

There are mainly two causes of the excessive rise in output voltage. The first cause is that, in a case that the rectifier circuit includes a coil, a winding ratio of the transformer is set so that the voltage across the secondary winding is greater than a rated output voltage. On the secondary side of the transformer, the secondary winding serving as the voltage source, the coil, and the rectifier element function as a step-down circuit. The step-down circuit is driven by the switching operation of the switching circuit, and a step-down ratio of the step-down circuit is determined by a duty ratio of the switching operation. As a result, taking into account the step-down ratio of the step-down circuit, the winding ratio of the transformer is set so that the voltage across the secondary winding is greater than the output voltage of the power supply. However, in a case that the output power is small, the step-down circuit may not operate as planned, and the output voltage may rise to near the level determined by the winding ratio of the transformer.

The second cause is that, in a case that the switching circuit performs the switching operation, ringing due to a parasitic capacitance component and an inductance component of the transformer and the coil occurs. The generated ringing applies a short but high voltage across the primary winding of the transformer. Thus, a voltage greatly exceeding the rated output voltage is generated for a short period of time across the secondary winding of the transformer, and current flows into the capacitor provided between the output terminals of the power supply. In a case that the output power is small, the charge is intermittently stored in the capacitor, causing an excessive rise in output voltage.

In the power supply according to each of the embodiments, the rectifier circuit having a small output power performs the power regeneration operation, causing power to be transmitted from the rectifier circuit having a small output power to the switching circuit or another rectifier circuit. The rectifier circuit having a small output power performs the discharge operation of discharging the capacitor and causing a current to flow into the secondary winding of the transformer. As a result, an excessive rise in output voltage is prevented, making it possible to stably output a plurality of voltages.

The technical concept described below can be applied to a variety of power supplies that include one switching circuit and a plurality of rectifier circuits. In each of the embodiments described below, specific examples of the switching circuit and the rectifier circuit will be described. Further, to facilitate understanding of the disclosure, a power supply provided with one switching circuit and one rectifier circuit will be described as a reference example for each of the embodiments prior to the description of the power supply according to the embodiment. In each of the reference examples, there will also be a description of the point at which zero voltage switching of the switching element included in the switching circuit is performed by the transmission of power from the rectifier circuit to the switching circuit. Among the constituent elements of the power supplies described below, constituent elements that are the same as those included in a power supply previously described are denoted by the same reference numerals, and descriptions thereof will be omitted.

### First Reference Example

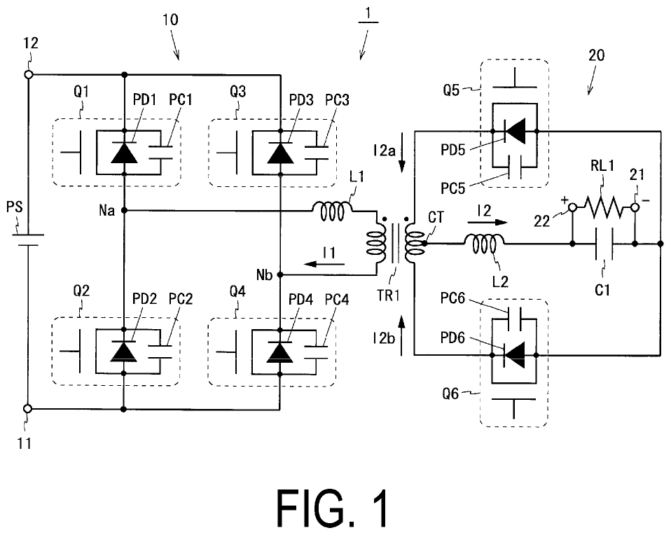

FIG. 1 is a circuit diagram of a power supply according to a first reference example. A power supply 1 illustrated in FIG. 1 is a DC/DC converter including Metal Oxide Semiconductor Field Effect Transistors (MOSFETs) Q1 to Q6 of an N-channel type, a transformer TR1, coils L1, L2, and a capacitor C1. The MOSFETs Q1 to Q6 respectively include parasitic diodes PD1 to PD6 and parasitic capacitors PC1 to PC6. Note that in a case that an electrostatic capacitance of the parasitic capacitors PC1 to PC6 is insufficient, a capacitor may be externally connected in parallel to the parasitic capacitors PC1 to PC6.

The power supply 1 includes a primary circuit 10 on a primary side of the transformer TR1 and a secondary circuit 20 on a secondary side of the transformer TR1. The primary circuit 10 includes a first input terminal 11 as a negative input terminal and a second input terminal 12 as a positive input terminal. The secondary circuit 20 includes a first output terminal 21 as a negative output terminal and a second output terminal 22 as a positive output terminal. A direct current power supply PS is connected between the first and second input terminals 11, 12, and a load RL1 is connected between the first and second output terminals 21, 22. Hereinafter, the voltage supplied from the direct current power supply PS is referred to as Vin.

The MOSFETs Q1 to Q6 are each a switching element including a source electrode (first conduction electrode), a drain electrode (second conduction electrode), and a gate electrode (control electrode) and are switched between an on state (conductive state) and an off state (non-conductive state) in accordance with a gate potential. The primary circuit 10 includes the MOSFETs Q1 to Q4 and the coil L1. The secondary circuit 20 includes the MOSFETs Q5, Q6, the coil L2, and the capacitor C1.

In the primary circuit 10, the source electrode of the MOSFET Q2 is connected to the first input terminal 11, the drain electrode of the MOSFET Q2 is connected to the source electrode of the MOSFET Q1, and the drain electrode of the MOSFET Q1 is connected to the second input terminal 12. The two MOSFETs Q2, Q1 connected in series are thus provided between the first and second input terminals 11, 12. Further, the MOSFETs Q4, Q3 similarly connected in series are provided between the first and second input terminals 11, 12. Hereinafter, a node connected to the midpoint between the MOSFETs Q1, Q2 is referred to as Na, a node connected to the midpoint between the MOSFETs Q3, Q4 is referred to as Nb, and potentials of the nodes Na, Nb are referred to as Va, Vb, respectively. The nodes Na, Nb are connected with the coil L1 and a primary winding of the transformer TR1 therebetween.

In the secondary circuit 20, the capacitor C1 is connected between the first and second output terminals 21, 22. The source electrodes of the MOSFETs Q5, Q6 are both connected to the first output terminal 21. The drain electrode of the MOSFET Q5 is connected to a first end (upper ends in the drawing) of a secondary winding of the transformer TR1. The drain electrode of the MOSFET Q6 is connected to a second end of the secondary winding of the transformer TR1. A center tap CT is provided on the secondary winding of the transformer TR1, and the center tap CT is connected to the second output terminal 22 with the coil L2 therebetween.

In this way, the primary circuit 10 is a switching circuit connected to the primary winding of the transformer TR1. This switching circuit is a full-bridge circuit. The secondary circuit 20 is a rectifier circuit connected to the secondary winding of the transformer TR1. This rectifier circuit is a center tap type full wave rectifier circuit. In the secondary circuit 20, a first end (right end in the drawing) of the capacitor C1 is connected to the first end of the secondary winding of the transformer TR1 with the MOSFET Q5 therebetween and is connected to the second end of the secondary winding of the transformer TR1 with the MOSFET Q6 therebetween. A second end of the capacitor C1 is connected to the center tap CT with the coil L2 therebetween. Both the MOSFETs Q5, Q6 are rectifier elements that rectify the power transmitted from the primary side of the transformer TR1, and the capacitor C1 stores the rectified power.

For the coils L1, L2, a coil having an inductance of from 10 to 100 μH, for example, is used. For the capacitor C1, a capacitor having a capacitance of from 20 to 1,000 μF, for example, is used. The inductance of the coils L1, L2 and the capacitance of the capacitor C1 may be values outside the ranges described above. Alternatively, a leakage magnetic flux of the transformer TR1 may be used in place of the coil L1.

Note that elements not required in the description of the operation of the circuits are omitted in the circuit diagram of the power supply. For example, while the power supply 1 is often provided with a capacitor between the first and second input terminals 11, 12 to rapidly supply a current to the full-bridge circuit, this capacitor is omitted in FIG. 1. In FIG. 1, a circuit for driving gate electrodes of the MOSFETs Q1 to Q6 is also omitted.

The primary circuit 10 generates an alternating current (a 100-kHz alternating current, for example) using a full-bridge circuit on the basis of the direct current supplied from the direct current power supply PS and supplies the generated alternating current to the primary winding of the transformer TR1. The transformer TR1 transforms the alternating current supplied to the primary winding and outputs the alternating current from the secondary winding. The secondary circuit 20 rectifies the transformed alternating current output from the secondary winding of the transformer TR1 to charge the capacitor C1. In this way, the power supply 1 converts the voltage level of the power supplied from the direct current power supply PS and supplies the power the converted voltage to the load RL1.

The relationship between the level of the direct current voltage supplied to the first and second input terminals 11, 12 and the level of the direct current voltage output from the first and second output terminals 21, 22 is mainly determined by the winding ratio of the transformer TR1. For example, in a case that the power supply 1 is used as an AC adapter for a laptop personal computer, the output voltage of the power supply 1 may be set to 19 V using the output voltage (a voltage of 400 V, for example) of a power factor correction circuit as the voltage supplied from the direct current power supply PS.

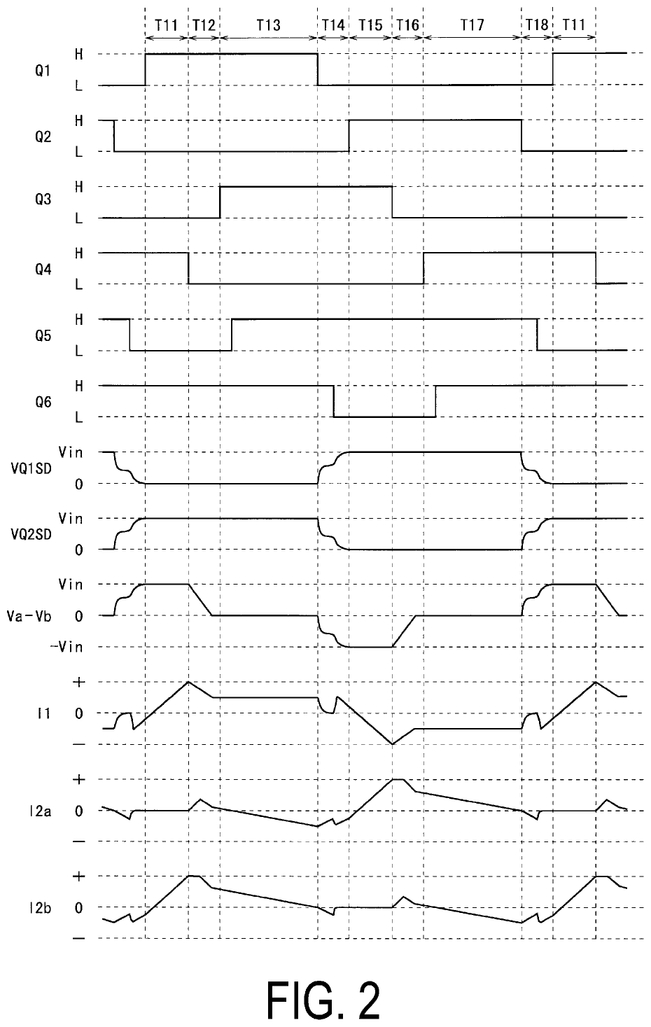

The operation of the power supply 1 in a case that the output power is relatively small (that is, in a case that the load RL1 is light) will now be described with reference to FIG. 2 to FIG. 13. FIG. 2 is a timing chart of the power supply 1 in a case that the output power is relatively small. FIG. 2 illustrates changes in the gate potential of the MOSFETs Q1 to Q6, a source-drain voltage VQ1SD of the MOSFET Q1, a source-drain voltage VQ2SD of the MOSFET Q2, a potential difference (Va−Vb) between the nodes Na, Nb, a current I1 flowing through the primary winding of the transformer TR1, a current I2a flowing through the MOSFET Q5, and a current I2b flowing through the MOSFET Q6. The MOSFETs Q1 to Q6 are turned on in a case that the gate potential is at a high level (denoted as H in the drawing) and turned off in a case that the gate potential is at a low level (denoted as L in the drawing). One cycle of operation of the power supply 1 is divided into eight periods T11 to T18.

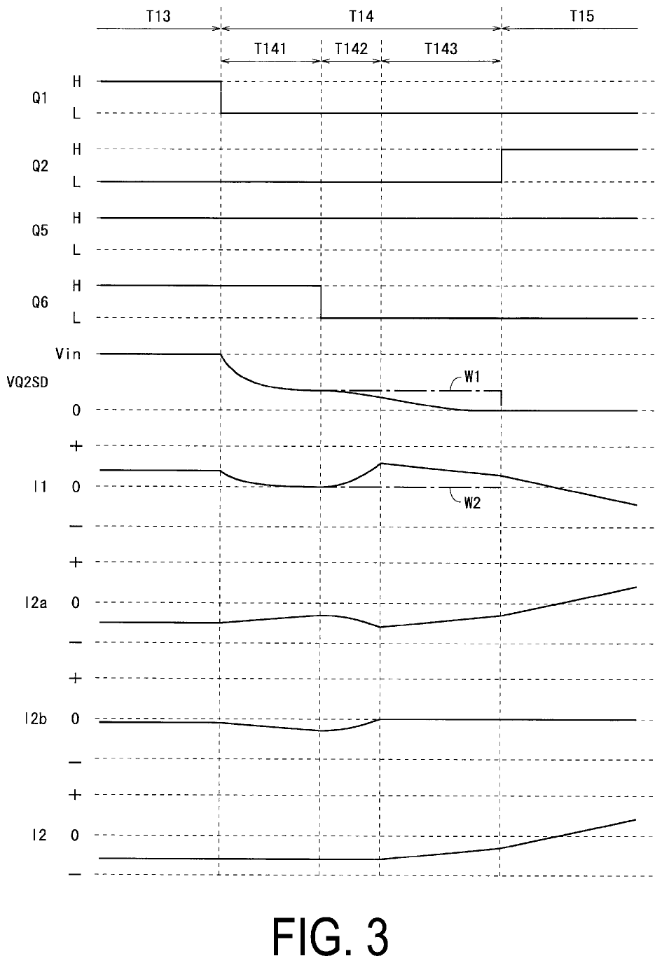

FIG. 3 is a diagram illustrating a portion of the timing chart illustrated in FIG. 2 in detail. In FIG. 3, the entire period T14 and portions of the periods T13, T15 are illustrated in an enlarged view. FIG. 3 illustrates the change in the current I2 flowing through the coil L2 in place of the changes in the gate potential of the MOSFETs Q3, Q4, the voltage VQ1SD, and the potential difference (Va−Vb). The current I2 is the sum of the currents I2a, I2b (I2=I2a+I2b). In a case that the current flowing through the load RL1 is negligible, the current I2 is equal to the current flowing through the capacitor C1. The positive orientations of the currents I1, I2a, I2b, I2 are as described in FIG. 1.

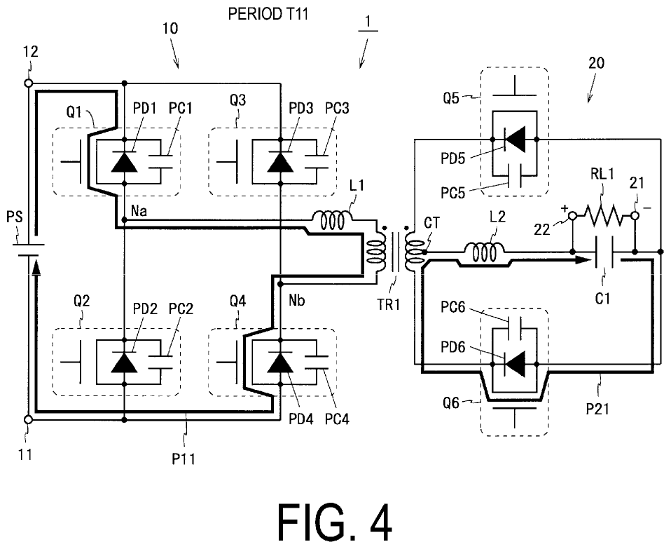

FIG. 4 is a current path diagram of the period T11. In the period T11, the MOSFETs Q1l, Q4, Q6 are in an on state, and the MOSFETs Q2, Q3, Q5 are in an off state. In the primary circuit 10, the current flows through a path P11 passing sequentially through the second input terminal 12, the MOSFET Q1, the coil L1, the primary winding of the transformer TR1, the MOSFET Q4, and the first input terminal 11. The current I1 increases over time, and the power is stored in the coil L1. In the secondary circuit 20, voltage is induced in the secondary winding of the transformer TR1. The current flows through a path P21 sequentially passing through the center tap CT, the coil L2, the capacitor C1, the MOSFET Q6, and the second end of the secondary winding of the transformer TR1. At this time, the capacitor C1 is charged. In the period T11, power is transmitted from the primary circuit 10 to the secondary circuit 20.

At the start of the period T12, the MOSFET Q4 is turned off. In the period T12, the MOSFETs Q1, Q6 are in an on state, and the MOSFETs Q2 to Q5 are in an off state. Since the MOSFET Q4 includes the parasitic capacitor PC4, the source-drain voltage of the MOSFET Q4 hardly rises when the MOSFET Q4 is turned off. Thus, the off operation of the MOSFET Q4 corresponds to zero voltage switching.

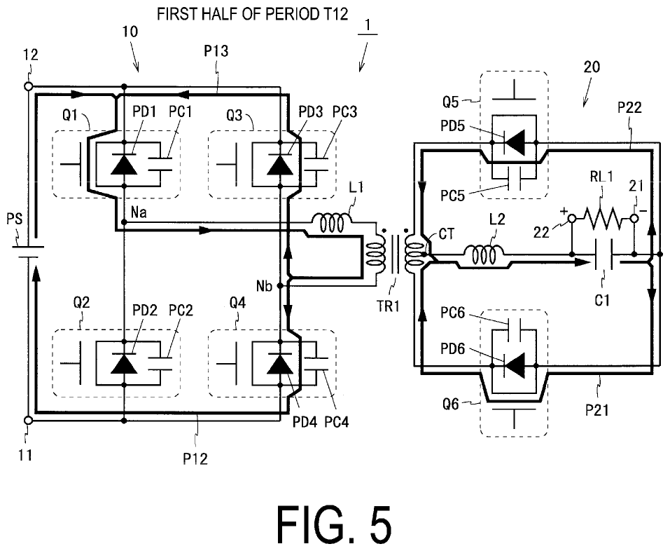

The current path in the primary circuit 10 changes in the middle of the period T12. Hereinafter, the period until the current path changes is referred to as a first half of the period T12, and the subsequent period is referred to as a second half of the period T12. FIG. 5 is a current path diagram of the first half of the period T12. In the primary circuit 10, the current flows through a path P12 passing sequentially through the second input terminal 12, the MOSFET Q1, the coil L1, the primary winding of the transformer TR1, the parasitic capacitor PC4, and the first input terminal 11; and a path P13 flowing through the parasitic capacitor PC3 after the primary winding of the transformer TR1. At this time, the parasitic capacitor PC3 is discharged, and the parasitic capacitor PC4 is charged. Thus, the potential of the node Nb rises, the potential difference (Va−Vb) between the nodes Na, Nb decreases, and the current I1 decreases. In the secondary circuit 20, the current continues to flow through the path P21 described above. Further, because the electromotive force of the secondary winding of the transformer TR1 is reduced, the parasitic capacitor PC5 is discharged. Thus, the current also flows through a path P22 sequentially passing through the center tap CT, the coil L2, the capacitor C1, the parasitic capacitor PC5, and the first end of the secondary winding of the transformer TR1.

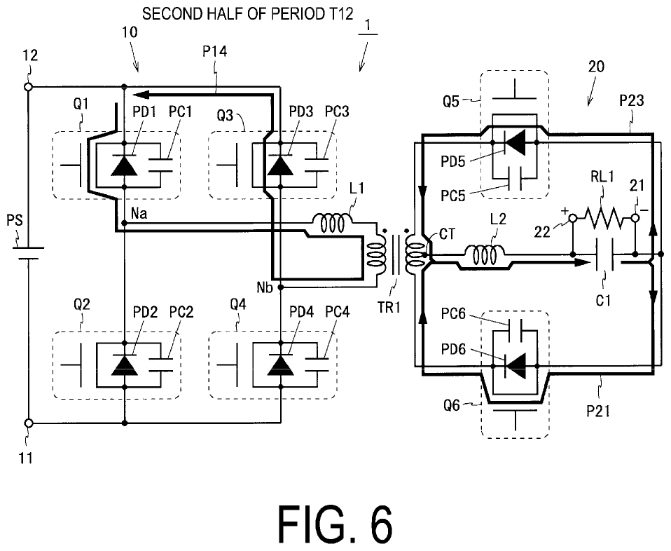

When the discharging of the parasitic capacitor PC3 and the charging of the parasitic capacitor PC4 are completed, the second half of the period T12 begins. FIG. 6 is a current path diagram of the second half of the period T12. In the primary circuit 10, the potential difference (Va−Vb) between the nodes Na, Nb is substantially zero. The current returns through a path P14 sequentially passing through the MOSFET Q1, the coil L1, the primary winding of the transformer TR1, and the parasitic diode PD3. At this time, the current I1 is substantially constant. In the secondary circuit 20, the current continues to flow through the path P21 described above and also flows through a path P23 sequentially passing through the center tap CT, the coil L2, the capacitor C1, the parasitic diode PDS, and the first end of the secondary winding of the transformer TR1. The currents I2a, I2b are both reduced by the action of the voltage across the capacitor C1.

The MOSFET Q3 is turned on at the start of the period T13, and the MOSFET Q5 is turned on in the middle of the period T13. Hereinafter, the period until the MOSFET Q5 is turned on is referred to as a first half of the period T13, and the subsequent period is referred to as a second half of the period T13. In the period T13, the MOSFETs Q1, Q3, Q6 are in an on state, and the MOSFETs Q2, Q4 are in an off state. The MOSFET Q5 is in an off state in the first half of the period T13 and an on state in the second half of the period T13. The MOSFET Q3 is turned on while the forward current flows to the parasitic diode PD3. Thus, the on operation of the MOSFET Q3 corresponds to zero voltage switching.

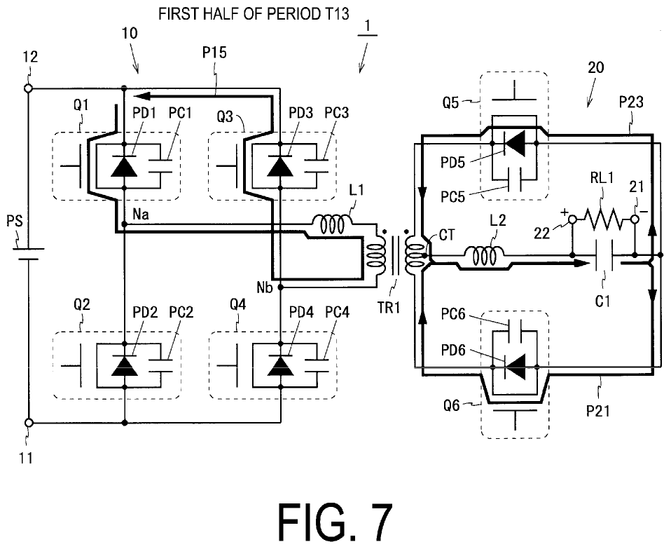

FIG. 7 is a current path diagram of the first half of the period T13. In the primary circuit 10, the current returns through a path P15 passing sequentially through the MOSFET Q1, the coil L1, the primary winding of the transformer TR1, and the MOSFET Q3. At this time, the current I1 is substantially constant. In the secondary circuit 20, the current continues to flow through the paths P21, P23 described above. The currents I2a, I2b are both continually reduced by the action of the voltage across the capacitor C1.

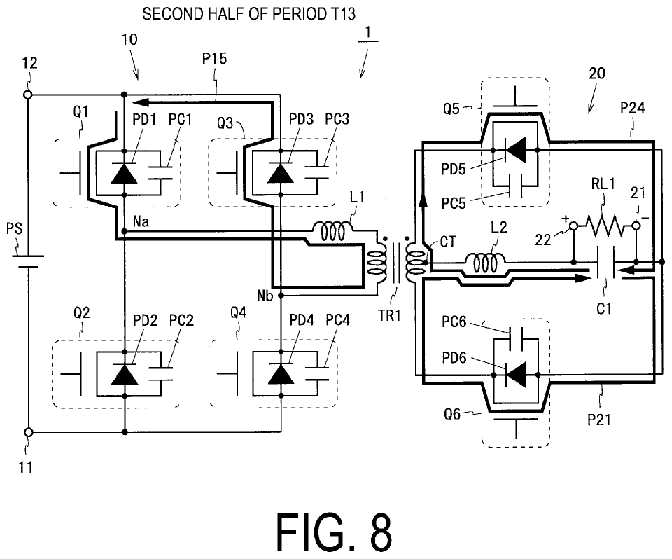

Before the current I2a becomes 0, the MOSFET Q5 is turned on, and the second half of the period T13 begins. FIG. 8 is a current path diagram of the second half of the period T13. In the primary circuit 10, the current continues to return through the path P15 described above. At this time, the current I1 is substantially constant. In the secondary circuit 20, soon after the MOSFET Q5 is turned on, the current I2a becomes negative (the orientation of the current I2a is reversed). At this time, the current flows through the path P21 described above; and a path P24 sequentially passing through the first end of the secondary winding of the transformer TR1, the MOSFET Q5, the capacitor C1, the coil L2, and the center tap CT. The current I2, which is the sum of the currents I2a, I2b, is positive in the first half of the period T13 and negative in the second half of the period T13. The capacitor C1 is charged in the first half of the period T13, and the capacitor C1 is discharged in the second half of the period T13. Eventually, the current I2b also becomes negative (the orientation of the current I2b is reversed).

The MOSFET Q1 is turned off at the start of the period T14, and the MOSFET Q6 is turned off in the middle of the period T14. In the period T14, the MOSFETs Q3, Q5 are in an on state, and the MOSFETs Q1, Q2, Q4 are in an off state. The MOSFET Q6 is in an on state until the middle of the period and subsequently in an off state. Since the MOSFET Q1 includes the parasitic capacitor PC1, the source-drain voltage of the MOSFET Q1 hardly rises when the MOSFET Q1 is turned off. Thus, the off operation of the MOSFET Q1 corresponds to zero voltage switching. As illustrated in FIG. 3, the period T14 is divided into a period T141 until the MOSFET Q6 starts the off operation, a period T142 until the current flowing through the MOSFET Q6 becomes 0, and a subsequent period T143.

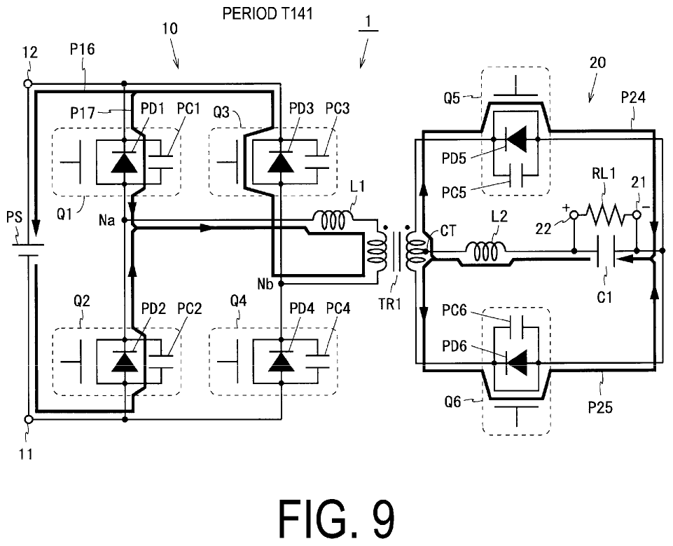

FIG. 9 is a current path diagram of the period T141. In the primary circuit 10, the current flows through a path P16 passing sequentially through the first input terminal 11, the parasitic capacitor PC2, the coil L1, the primary winding of the transformer TR1, the MOSFET Q3, and the secondary input terminal 12; and through a path P17 passing through the parasitic capacitor PC1 after the MOSFET Q3. At this time, the parasitic capacitor PC1 is charged, and the parasitic capacitor PC2 is discharged. Thus, the potential (and the voltage VQ2SD) of the node Na is reduced. In the period T141, the current flows toward the second input terminal 12, which is a positive input terminal. To make the current flow, the power stored in the coil L1 is used. Thus, the current I1 rapidly decreases and eventually becomes zero. In the secondary circuit 20, the current flows through the path P24 described above; and a path P25 sequentially passing through the second end of the secondary winding of the transformer TR2, the MOSFET Q6, the capacitor C1, the coil L2, and the center tap CT. In the period T141, the current I1 decreases, and thus the current I2a increases and the current I2b decreases. The current I2 continues to decrease.

In a case that the output power of the power supply 1 is relatively large (that is, in a case that the load RL1 is heavy), the current I1 during the period T13 is large, and the power stored in the coil L1 is also large. Thus, in the period T14, the voltage VQ2SD becomes zero before the current I1 becomes 0. Thus, the off operation of the MOSFET Q2 corresponds to zero voltage switching. On the other hand, in a case that the output power is relatively small, the voltage VQ2SD has not yet reached zero when the current I1 becomes zero. Thus, without special ingenuity, the off operation of the MOSFET Q2 does not correspond to zero voltage switching. In the power supply 1, to make the off operation of the MOSFET Q2 correspond to zero voltage switching, the MOSFET Q6 is turned off at the start of the period T142.

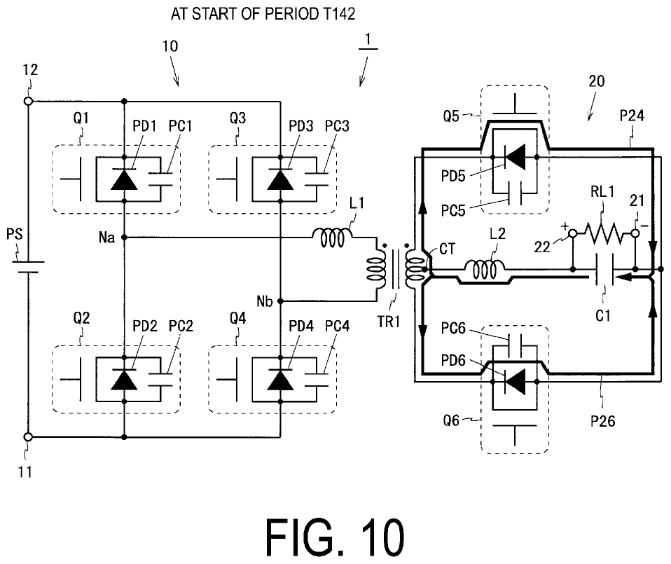

FIG. 10 is a current path diagram of the start of the period T142 (the moment the MOSFET Q6 is turned off). At this time, current does not flow in the primary circuit 10. In the secondary circuit 20, the current flows through the path P24 described above; and a path P26 sequentially passing through the second end of the secondary winding of the transformer TR1, the parasitic capacitor PC6, the capacitor C1, the coil L2, and the center tap CT. At this time, the parasitic capacitor PC6 is charged. In the period T142, as the charging of the parasitic capacitor PC6 progresses, the current I2b increases closer to zero while the current I2a decreases. Thus, the current flowing through the secondary winding of the transformer TR1 flows substantially from the second end toward the first end of the secondary winding (from a lower end toward an upper end in the drawing). This induces a voltage in the primary winding of the transformer TR1, and the current I1 increases once again.

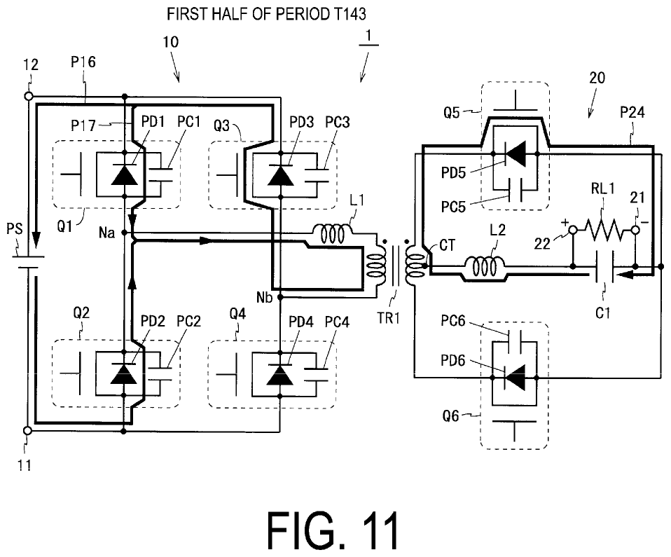

The current path in the primary circuit 10 changes in the middle of the period T143. Hereinafter, the period until the current path changes is referred to as a first half of the period T143, and the subsequent period is referred to as a second half of the period T143. FIG. 11 is a current path diagram of the first half of the period T143. In the primary circuit 10, the current flows once again through the same paths as those in the period T141 (paths P16, P17 described above). As a result, the charging of the parasitic capacitor PC1 and the discharging of the parasitic capacitor PC2 are resumed. Thus, the potential of the node Na (and the voltage VQ2SD) is reduced once again. In the secondary circuit 20, the current flows through the path P24 described above.

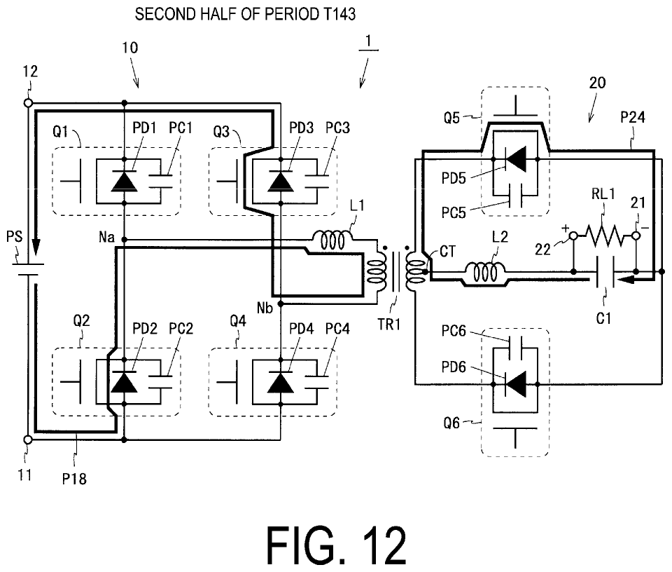

When the voltage VQ2SD becomes substantially zero, the second half of the period T143 begins. FIG. 12 is a current path diagram of the second half of the period T143. In the primary circuit 10, the current flows through a path P18 passing sequentially through the first input terminal 11, the parasitic diode PD2, the coil L1, the primary winding of the transformer TR1, the MOSFET Q3, and the second input terminal 12. In the secondary circuit 20, the current continues to flow through the path P24 described above.

In this way, in the period T14, the capacitor C1 is discharged. Further, in the secondary circuit 20, the discharge current of the capacitor C1 flows substantially from the second end toward the first end of the secondary winding of the transformer TR1, inducing voltage in the primary winding of the transformer TR1. As a result, in the primary circuit 10, the current I1 flows in a direction that sets the source-drain voltage of the MOSFET Q2 to zero.

At the start of the period T15, the MOSFET Q2 is turned on. At the start of the period T15, the voltage VQ2SD is substantially zero, and a forward current is flowing to the parasitic diode PD2. Thus, the on operation of the MOSFET Q2 corresponds to zero voltage switching. Note that in a case that the MOSFET Q6 is not turned off in the middle of the period T14 (that is, in a case that substantially no current flows from the second end to the first end of the secondary winding of the transformer TR1), the voltage VQ2SD and the current I1 change as indicated by the dot-dash lines W1 and W2 in FIG. 3, respectively. The off operation of the MOSFET Q2 in this state does not correspond to zero voltage switching.

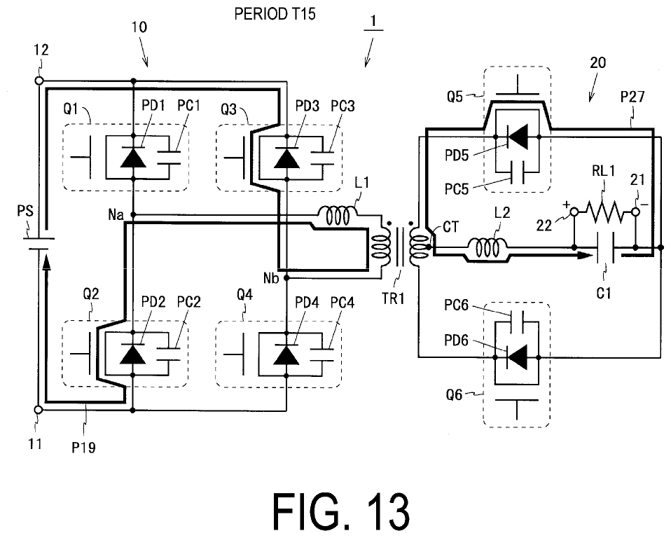

FIG. 13 is a current path diagram of the period T15. In the period T15, the MOSFETs Q2, Q3, Q5 are in an on state, and the MOSFETs Q1, Q4, Q6 are in an off state. In the primary circuit 10, the current flows through a path P19 passing sequentially through the second input terminal 12, the MOSFET Q3, the primary winding of the transformer TR1, the coil L1, the MOSFET Q2, and the first input terminal 11. In the secondary circuit 20, voltage is induced in the secondary winding of the transformer TR1. The current flows through a path P27 sequentially passing through the center tap CT, the coil L2, the capacitor C1, the MOSFET Q5, and the first end of the secondary winding of the transformer TR1. At this time, the capacitor C1 is charged. In the period T15, compared to the period T11, the orientation of the current flowing through the primary winding of transformer TR1 is reversed, and the orientation of the current flowing through the secondary winding of transformer TR1 is also reversed.

In the periods T15 to T18, the power supply 1 operates symmetrically with the periods T11 to T14. Specifically, the operation of the MOSFETs Q1 to Q6 in the periods T15 to T18 is the same as the operation of the MOSFETs Q3, Q4, Q1, Q2, Q6, Q5 in the periods T11 to T14, respectively. The changes in the currents I2a, I2b in the periods T15 to T18 are the same as the changes in the currents I2b, I2a in the periods T11 to T14. The changes in the current I1 in the periods T15 to T18 are opposite to the changes in the current I1 in the periods T11 to T14 (absolute values are the same; positive and negative values are reversed).

In the power supply 1, before the MOSFET Q2 is turned on, the capacitor C1 starts discharging. In the period T141, the current flows through the path P24 passing through the coil L2, the center tap CT, and the MOSFET Q5; and the path P25 passing through the coil L2, the center tap CT, and the MOSFET Q6, from a positive electrode terminal (terminal on the left side in the drawing) toward a negative electrode terminal (terminal on the right side in the drawing) of the capacitor C1 (refer to FIG. 9). When the MOSFET Q6 is turned off at the start of the period T142, the current I2a flowing through the path P24 decreases and the current I2b flowing through the path P25 becomes zero (refer to FIG. 3). As a result, the current flows substantially from the second end to the first end of the secondary winding of the transformer TR1, voltage is induced in the primary winding of the transformer TR1, and the current I1 flows. The flow of the current I1 reduces the voltage VQ2SD.

A switching loss can be reduced by turning the MOSFET Q2 on after the voltage VQ2SD is reduced. In particular, the switching loss can be reduced by turning the MOSFET Q2 on after the voltage VQ2SD is reduced to substantially 0. Thus, in the power supply 1, the power stored in the capacitor C1 of the secondary circuit 20 is transmitted to the primary circuit 10, and after the source-drain voltage of the MOSFET Q2 is reduced, the MOSFET Q2 is turned on. As a result, the switching loss can be reduced at the on operation of the MOSFET Q2. In the power supply 1, using this same method, the switching loss at the on operation of the MOSFETs Q1, Q3, Q4 is reduced.

Preferred conditions for a current flowing substantially from the second end toward the first end of the secondary winding of the transformer TR1 will now be described. The stored energy (Eoss) of each output capacity (Coss) of the MOSFETs Q1, Q2 are denoted as E1, E2, respectively, and the total energy of the current substantially flowing from the second end toward the first end of the secondary winding of the transformer TR1 is denoted as E3. The output capacity is the sum of a drain-to-source capacity Cds and a gate-to-drain capacity Cgd. The stored energies E1, E2 of the output capacities are each found by integrating the output capacity with voltage and indicate the energy of the output capacity. The total energy E3 is found by integrating the product of the current and the voltage across the secondary winding of the transformer TR1 in the period from when the current begins to substantially flow from the second end toward the first end of the secondary winding of the transformer TR1 until the MOSFET Q2 is turned on.

The total energy E3 preferably satisfies the following relationship (1):

0.1×(E1+E2)<E3<10×(E1+E2) (1)

In a case that the total energy E3 is less than a lower limit of relationship (1), the source-drain voltage of the MOSFET Q2 cannot be sufficiently reduced. On the other hand, in a case that the total energy E3 is greater than an upper limit value of relationship (1), the conduction loss in a case that the current flows through the paths P18, P24 in the second half of the period T143 (FIG. 12) increases, greatly impairing the effect of a reduction in loss resulting from making the off operation of the MOSFET Q2 correspond to zero voltage switching.

Further, preferred conditions will now be described for performing the series of operations from discharging the capacitor C1 to reducing the voltage VQ2SD. The DC/DC converter may operate in a mode in which the output voltage is gradually increased for circuit protection at startup (soft start). Further, the output voltage of the DC/DC converter may vary within a certain range. In a case that the output voltage is significantly low at such a time, the power accumulated in the capacitor C1 becomes small. As a result, the time required for the series of operations described above significantly lengthens, possibly lengthening one cycle of the operation of the power supply 1. Preferably, therefore, the series of operations described above is performed only when the output voltage is greater than 50% of the rated value, for example. Note that the two types of preferred conditions described above are applied not only to the present reference example, but also to the embodiments and other reference examples described below.

### First Embodiment

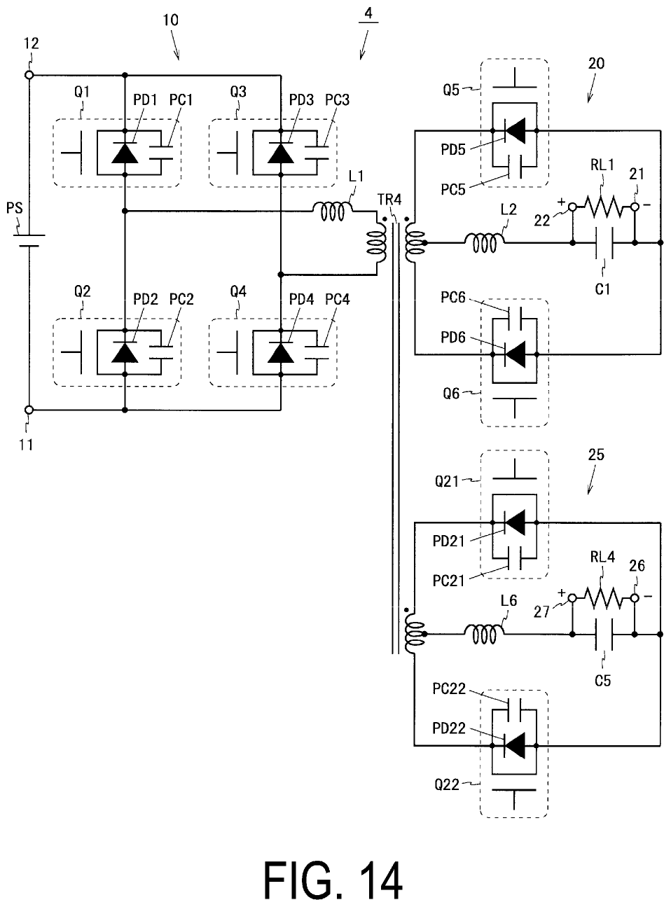

FIG. 14 is a circuit diagram of a power supply according to a first embodiment. A power supply 4 illustrated in FIG. 14 is a DC/DC converter including MOSFETs Q1 to Q6, Q21, Q22, a transformer TR4, coils L1, L2, L6 and capacitors C1, C5. The power supply 4 is configured by adding a secondary circuit 25 to the power supply 1 according to the first reference example and thus includes the plurality of secondary circuits 20, 25. For each of the secondary circuits 20, 25, a rated output voltage and a rated output current can be set. Note that the power supply 4 may include three or more secondary circuits.

The secondary circuit 25 has the same configuration as the secondary circuit 20. The secondary circuit 25 includes the MOSFETs Q21, Q22, the capacitor C5, and the coil L6. The secondary circuit 25 includes a first output terminal 26 as a negative output terminal and a second output terminal 27 as a positive output terminal. The MOSFETs Q21, Q22 respectively include parasitic diodes PD21, PD22 and parasitic capacitors PC21, PC22. A load RL4 is connected between the first and second output terminals 26, 27. The transformer TR4 includes two secondary windings. The secondary circuits 20, 25 share the transformer TR4 and are respectively supplied with power from the two secondary windings of the transformer TR4.

Hereinafter, a case in which the output power of the secondary circuit 20 is less than the output power of the secondary circuit 25 will be described. In this case, without special ingenuity, the output voltage of the secondary circuit 20 may rise more than necessary (excessive rise in output voltage). For example, in a case that the output power of the secondary circuit 20 is 5 W or less and the output power of the secondary circuit 25 is 100 W, the output voltage of the secondary circuit 20 may rise to nearly twice the rated output voltage.

In the power supply 4, to prevent an excessive rise in output voltage, the primary circuit 10 and the secondary circuit 20 operate in the same manner as in the first reference example. As a result, power is transmitted from the secondary circuit 20 to the primary circuit 10 and the secondary circuit 25, and thus the output voltage of the secondary circuit 20 can be reduced to the rated output voltage.

In general, in a power supply provided with a plurality of secondary circuits, in a case that one secondary circuit transmits power to perform an operation of reducing the output voltage to an appropriate level (hereinafter referred to as a voltage optimization operation), whether power is transmitted to the primary circuit or the other second secondary circuit is determined by the circuit configuration and the like. In the power supply 4, power is preferentially transmitted to the secondary circuit 25. In a case that the power is large, the power is transmitted to both the primary circuit 10 and the secondary circuit 25. The reason for this is as follows.

In the primary circuit 10, since the coil L1 and the primary winding of the transformer TR4 are connected in series, the amount of current flowing through the coil L1 and the amount of current flowing through the primary winding of the transformer TR4 are the same. On the other hand, in the secondary circuit 25, the coil L6 is connected to the center tap of the secondary winding of the transformer TR4. Thus, the current flowing through the coil L6 is divided into a current flowing through the MOSFET Q21 and a current flowing through the MOSFET Q22 (hereinafter, the former is referred to as a first current and the latter referred to as a second current). Thus, by changing the amount of the first current and the amount of the second current, it is possible to change the effective value of the current flowing through the secondary winding of the transformer TR4 in a particular direction without changing the amount of current flowing through the coil L6. This operation is performed in the rectifier circuit serving as the power transmission source. Operation examples are described in FIG. 10, FIG. 11, and the period T142 illustrated in FIG. 3, for example. Thus, in a case that the amount of the first current or the second current becomes 0, it is no longer possible to change the effective value of the current flowing through the secondary winding of the transformer TR4 in a particular direction without changing the amount of current flowing through the coil L6. Subsequently, the power is transmitted not only to the secondary circuit 25 but to the primary circuit 10 as well.

In a case that the secondary circuit 20 performs the voltage optimization operation, a plurality of methods are considered for the operation of the secondary circuit 25. For example, the MOSFETs Q21, Q22 may be continually controlled in an off state (first method). In a case that the first method is used, in the secondary circuit 25, a majority of the current flows through the parasitic diodes PD21, PD22. As a result, the output voltage drops by a forward voltage Vf of the parasitic diodes, resulting in a loss. Alternatively, the MOSFETs Q21, Q22 may be controlled in an on state for the period in which the current flows from the anode electrode to the cathode electrode of the parasitic diodes PD21, PD22 (second method). The second method is so-called synchronous rectification. In the first reference example, after the MOSFETs Q5, Q6 are turned on, current flows from the drain electrodes toward the source electrodes of the MOSFETs Q5, Q6 (from the cathode electrodes toward the anode electrodes of the parasitic diodes PDS, PD6). In the secondary circuit 20, the current needs to flow as described above in order to perform the voltage optimization operation. On the other hand, because the secondary circuit 25 does not need to perform the voltage optimization operation, regular synchronous rectification may be performed. Alternatively, the MOSFETs Q21, Q22 may be turned on/off at the same timing as the MOSFETs Q5, Q6 (third method). In a case that the third method is used, power is transmitted from the secondary circuit 25 to the primary circuit 10. However, since the output power of the secondary circuit 25 is large, even in a case where power is transmitted from the secondary circuit 25 to the primary circuit 10, the output voltage of the secondary circuit 25 is substantially unaffected.

The voltage optimization operation performed by the secondary circuit 20 can also be regarded as a power regeneration operation in which the secondary circuit 20 transmits power to the primary circuit 10 or the secondary circuit 25. Further, the voltage optimization operation performed by the secondary circuit 20 can also regarded as a discharge operation in which the capacitor C1 is discharged, causing current to flow through the secondary winding of the transformer TR4. The output power may be measured using a sensor (not illustrated), and the secondary circuit 20 perform a voltage optimization operation in a case that the measured value of the output power is below a reference value. Or, the output voltage may be measured using a sensor, and the secondary circuit 20 perform a voltage optimization operation in a case that the measured value of the output voltage is above a reference value.

Conversely to the above-described case, in a case that the output power of the secondary circuit 25 is less than the output power of the secondary circuit 20, to prevent an excessive rise in output voltage of the secondary circuit 25, the secondary circuits 20, 25 may respectively perform the operations of the secondary circuits 25, 20 described above.

The power supply 4 according to the present embodiment includes the transformer TR4 provided with the primary winding and the plurality of (two) secondary windings, the switching circuit (the primary circuit 10) connected to the primary winding, and the plurality of rectifier circuits (the two secondary circuits 20, 25) connected to the plurality of secondary windings, respectively. At least one (the secondary circuit 20) of the rectifier circuits is configured to perform a power regeneration operation of transmitting power to the switching circuit or the other rectifier circuit (the secondary circuit 25). Further, at least one of the plurality of rectifier circuits includes a rectifier element (the MOSFETs Q5, Q6) configured to rectify the power transmitted from a primary side of the transformer TR4, includes the capacitor C1 configured to accumulate the rectified power, and is configured to perform a discharge operation of discharging the capacitor C1 and causing a current to flow into the secondary winding of the transformer TR4.

The rectifier circuit having a small output power thus performs the power regeneration operation (a discharge operation of discharging the capacitor C1 and causing a current to flow into the secondary winding of the transformer TR4), transmitting power from the rectifier circuit having a small output power to the switching circuit or the other rectifier circuit. This makes it possible to prevent an excessive increase in output power in the rectifier circuit having a small output power. Accordingly, it is possible to provide a power supply capable of stably outputting a plurality of voltages.

Further, at least one of the rectifier circuits includes first and second switching elements (the MOSFETs Q5, Q6) as rectifier elements and the coil L2, and at least one of the secondary windings includes a center tap. In at least one of the rectifier circuits, the first end (right end in the drawing) of the capacitor C1 is connected to the first end (upper end in the drawing) of the secondary winding with the first switching element (MOSFET Q5) therebetween and is connected to the second end (lower end in the drawing) of the secondary winding with the second switching element (MOSFET Q6) therebetween, and the second end (left end in the drawing) of the capacitor C1 is connected to the center tap with the coil L2 therebetween. At least one of the rectifier circuits performs, as the discharge operation, an operation of making a current flow into the path P24 passing through the coil L2, the center tap, the first end of the secondary winding, and the first switching element; and the path P25 passing through the coil L2, the center tap, the second end of the secondary winding, and the second switching element to start discharge of the capacitor C1; and an operation of subsequently turning off the second switching element.

Thus, in the rectifier circuit having the configuration described above, a current is made to flow through the two paths P24, P25 to start discharge of the capacitor C1, and subsequently the second switching element is turned off, making it possible to cause a current to flow into the secondary winding of the transformer TR4 and to transmit power from the rectifier circuit to the switching circuit or the other rectifier circuit. Further, the rectifier circuit can be configured so that current flows into a path passing through only one rectifier element (the MOSFET Q5 or Q6) between the transformer TR4 and the capacitor C2, reducing a pass-through loss. Accordingly, it is possible to provide a power supply capable of stably outputting a plurality of voltages and having a high power-conversion efficiency.

Further, the switching circuit is a full-bridge circuit. Accordingly, it is possible to provide a power supply that includes a full-bridge circuit as the switching circuit and is capable of stably outputting a plurality of voltages.

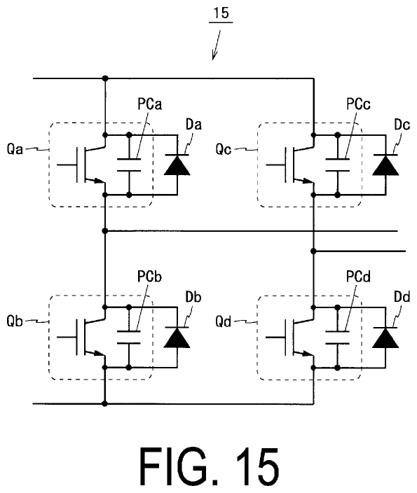

The power supply 4 according to the present embodiment can constitute the following modified example. FIG. 15 is a circuit diagram of a primary circuit of a power supply according to a modified example of the present embodiment. A primary circuit 15 illustrated in FIG. 15 is a full-bridge circuit including four Insulated Gate Bipolar Transistors (IGBTs) Qa to Qd. The IGBTs Qa to Qd are negative-positive-negative (NPN) type IGBTs, respectively including parasitic capacitors PCa to PCd. Diodes Da to Dd are respectively connected in parallel to the IGBTs Qa to Qd.

In general, in a case that a switching circuit configured using a MOSFET is configured using a bipolar transistor, the source electrode and the drain electrode of the MOSFET may be replaced with an emitter electrode and a collector electrode of a bipolar transistor, respectively. The primary circuit 15 is obtained by performing the replacement described above for the primary circuit 10 illustrated in FIG. 1. The IGBTs Qa to Qd respectively perform the same operations as those of the MOSFETs Q1 to Q4 included in the primary circuit 10.

The power supply including the full-bridge circuit configured by using the IGBTs also has the same effect as that of the power supply including the full-bridge circuit configured by using the MOSFETs. Note that, although an NPN-type IGBT is used here, a positive-negative-positive (PNP) type IGBT may be used. Further, the MOSFET included in the secondary circuit may be replaced with a circuit in which the IGBT and the diode are connected with each other in parallel. In addition, a bipolar transistor, a silicon carbide (SiC)-MOSFET, a gallium nitride (GaN)-MOSFET, or the like may be used in place of the IGBT.

### Second Reference Example

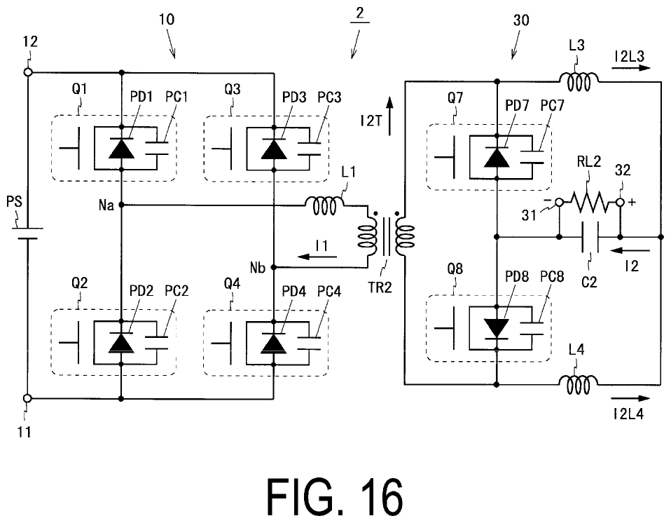

FIG. 16 is a circuit diagram of a power supply according to a second reference example. A power supply 2 illustrated in FIG. 16 is a DC/DC converter including N-channel type MOSFETs Q1 to Q4, Q7, Q8, a transformer TR2, coils L1, L3, L4, and a capacitor C2. The power supply 2 includes the primary circuit 10 on the primary side of the transformer TR2 and a secondary circuit 30 on the secondary side of the transformer TR2. The configuration and operation of the primary circuit 10 are the same as those of the first reference example.

The MOSFETs Q7, Q8 are switching elements similar to the MOSFETs Q1 to Q6. The secondary circuit 30 includes the MOSFETs Q7, Q8, the coils L3, L4, and the capacitor C2. The secondary circuit 30 includes a first output terminal 31 as a negative output terminal and a second output terminal 32 as a positive output terminal. The capacitor C2 is connected between the first and second output terminals 31, 32. The source electrodes of the MOSFETs Q7, Q8 are both connected to the first output terminal 31. The drain electrode of the MOSFET Q7 is connected to a first end (upper end in the drawing) of the secondary winding of the transformer TR2 and is connected to a first end (left end in the drawing) of the coil L3. The drain electrode of the MOSFET Q8 is connected to a second end of the secondary winding of the transformer TR2 and is connected to a first end (left end in the drawing) of the coil L4. The second ends of the coils L3, L4 are both connected to the second output terminal 32.

The secondary circuit 30 is thus a rectifier circuit connected to the secondary winding of the transformer TR2. This rectifier circuit is a current doubler type of full wave rectifier circuit. In the secondary circuit 30, a first end (left end in the drawing) of the capacitor C2 is connected to the first end of the secondary winding of the transformer TR2 with the MOSFET Q7 therebetween and is connected to the second end of the secondary winding of the transformer TR2 with the MOSFET Q8 therebetween. The second end of the capacitor C2 is connected to the first end of the secondary winding of the transformer TR2 with the coil L3 therebetween and is connected to the second end of the secondary winding of the transformer TR2 with the coil L4 therebetween. Both the MOSFETs Q7, Q8 are rectifier elements that rectify the power transmitted from the primary side of the transformer TR2, and the capacitor C2 stores the rectified power.

For the coils L3, L4, a coil having an inductance of from 10 to 100 μH, for example, is used. For the capacitor C2, a capacitor having a capacitance of from 20 to 1,000 μF, for example, is used. The inductance of the coils L3, L4 and the capacitance of the capacitor C2 may be values outside the ranges described above.

The primary circuit 10 operates in the same manner as in the first reference example. The transformer TR2 transforms the alternating current supplied to the primary winding and outputs the alternating current from the secondary winding. In the secondary circuit 30, the transformed alternating current output from the secondary winding of the transformer TR2 is rectified to charge the capacitor C2. In this way, the power supply 2 converts the voltage level of the power supplied from the direct current power supply PS and supplies the power in the converted voltage to a load RL2.

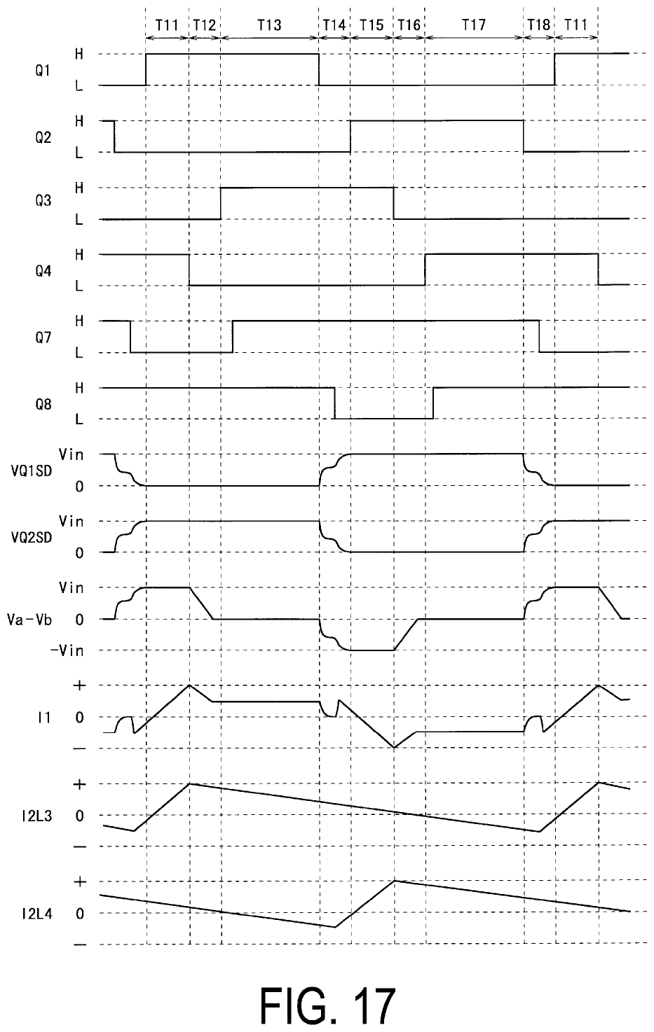

The operation of the power supply 2 in a case that the output power is relatively small will now be described with reference to FIG. 17 to FIG. 25. FIG. 17 is a timing chart of the power supply 2 in a case that the output power is relatively small. FIG. 17 illustrates changes in the gate potential of the MOSFETs Q1 to Q4. Q7, Q8, the source-drain voltage VQ1SD of the MOSFET Q1, the source-drain voltage VQ2SD of the MOSFET Q2, the potential difference (Va−Vb) between the nodes Na, Nb, the current I1 flowing through the primary winding of the transformer TR1, a current I2L3 flowing through the coil L3, and a current I2L4 flowing through the coil L4. One cycle of operation of the power supply 2 is divided into the eight periods T11 to T18.

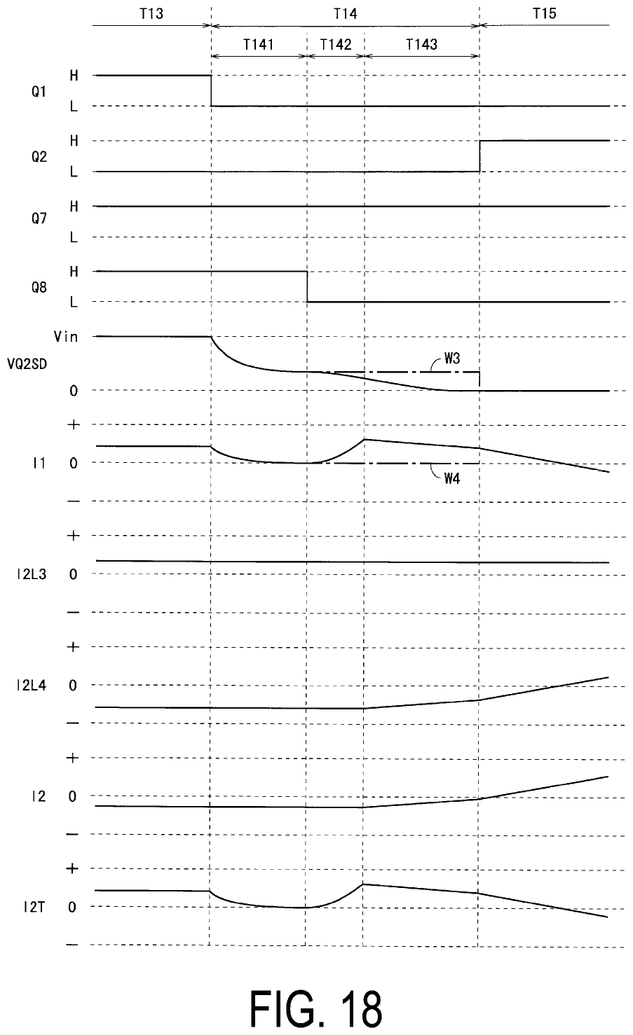

FIG. 18 is a diagram illustrating a portion of the timing chart illustrated in FIG. 17 in detail. In FIG. 18, the entire period T14 and portions of the periods T13, T15 are described in an enlarged view. FIG. 18 illustrates the change in the currents I2, I2T in place of the changes in the gate potential of the MOSFETs Q3, Q4, the voltage VQ1SD, and the potential difference (Va−Vb). The current I2 is the sum of the currents I2L3, I2L4 (I2=I2L3+I2L4), and the current I2T is the current flowing through the secondary winding of the transformer TR2. In a case that the current flowing through the load RL2 is negligible, the current I2 is equal to the current flowing through the capacitor C2. The positive orientations of the currents I1, I2L3, I2L4, I2, I2T are as described in FIG. 16.

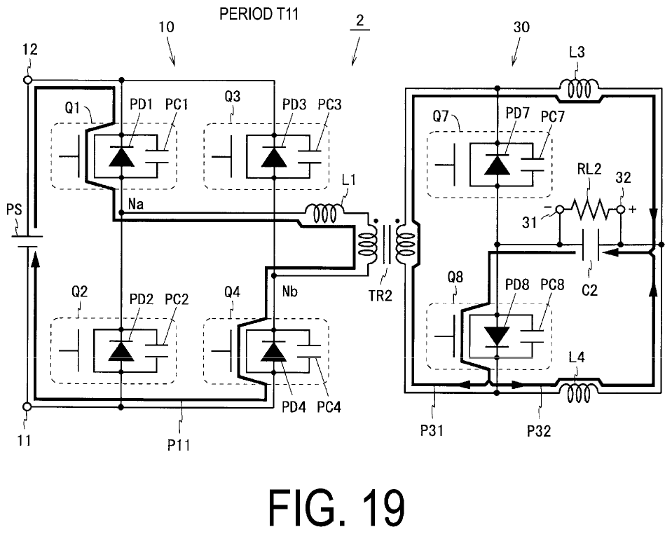

FIG. 19 is a current path diagram of the period T11. In the period T11, the MOSFETs Q1, Q4, Q8 are in an on state, and the MOSFETs Q2, Q3, Q7 are in an off state. In the primary circuit 10, the current flows through the path P11 described above. The current I1 increases over time, and the power is stored in the coil L1. In the secondary circuit 30, voltage is induced in the secondary winding of the transformer TR2. The current flows through a path P31 sequentially passing through the first end of the secondary winding of the transformer TR2, the coil L3, the capacitor C2, the MOSFET Q8, and the second end of the secondary winding of the transformer TR2. The current I2L3 increases over time, and the power is stored in the coil L3. Because power stored before the first half cycle remains in the coil L4, the current also flows in a path P32 sequentially passing through the second end of the coil L4, the capacitor C2, the MOSFET Q8, and the first end of the coil L4. At this time, the capacitor C2 is charged. In the period T11, power is transmitted from the primary circuit 10 to the secondary circuit

At the start of the period T12, the MOSFET Q4 is turned off. In the period T12, the MOSFETs Q1, Q8 are in an on state, and the MOSFETs Q2 to Q4, Q7 are in an off state. For the same reason as in the first reference example, the off operation of the MOSFET Q4 corresponds to zero voltage switching.

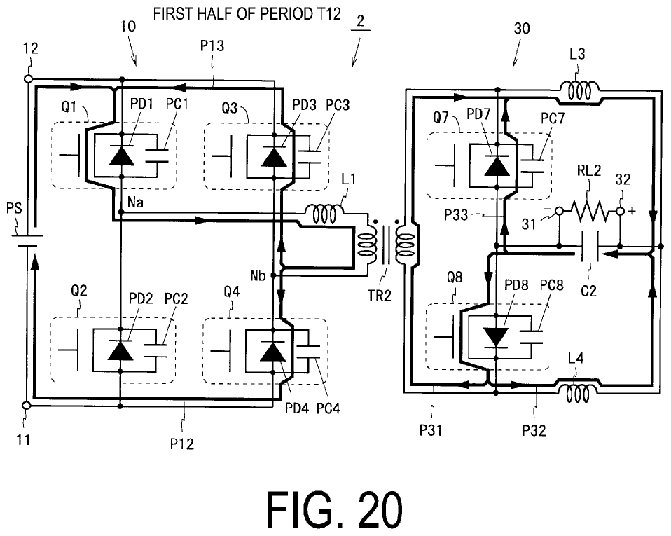

Similar to the first reference example, the current path in the primary circuit 10 changes in the middle of the period T12. FIG. 20 is a current path diagram of the first half of the period T12. In the primary circuit 10, the current flows through the paths P12, P13 described above. At this time, the parasitic capacitor PC3 is discharged, and the parasitic capacitor PC4 is charged. Thus, the potential of the node Nb rises, the potential difference (Va−Vb) between the nodes Na, Nb decreases, and the current I1 decreases. In the secondary circuit 20, the current continues to flow through the paths P31, P32 described above. Further, because the electromotive force of the secondary winding of the transformer TR2 is reduced, a parasitic capacitor PC7 is discharged. Thus, the current also flows in a path P33 sequentially passing through the first output terminal 31, the parasitic capacitor PC7, the coil L3, and the second output terminal 32.

When the discharging of the parasitic capacitor PC3 and the charging of the parasitic capacitor PC4 are completed, the second half of the period T12 begins. In the primary circuit 10, the potential difference (Va−Vb) between the nodes Na, Nb becomes substantially zero, and the current returns through the path P14 described above (refer to FIG. 6). At this time, the current I1 is substantially constant. In the secondary circuit 30, the current continues to flow through the paths P31 to P33 described above. The currents I2L3, I2L4 are both reduced by the action of the voltage across the capacitor C2.

The MOSFET Q3 is turned on at the start of the period T13, and the MOSFET Q7 is turned on in the middle of the period T13. Hereinafter, the period until the MOSFET Q7 is turned on is referred to as a first half of the period T13, and the subsequent period is referred to as a second half of the period T13. In the period T13, the MOSFETs Q1, Q3, Q8 are in an on state, and the MOSFETs Q2, Q4 are in an off state. The MOSFET Q7 is in an off state in the first half of the period T13 and an on state in the second half of the period T13. For the same reason as in the first reference example, the on operation of the MOSFET Q3 corresponds to zero voltage switching.

In the first half of the period T13, in the primary circuit 10, the current flows through the path P15 described above (see FIG. 7). At this time, the current I1 is substantially constant. In the secondary circuit 30, the current continues to flow through the paths P31 to P33 described above. The currents I2L3, I2L4 both continue to be reduced by the action of the voltage across the capacitor C2.

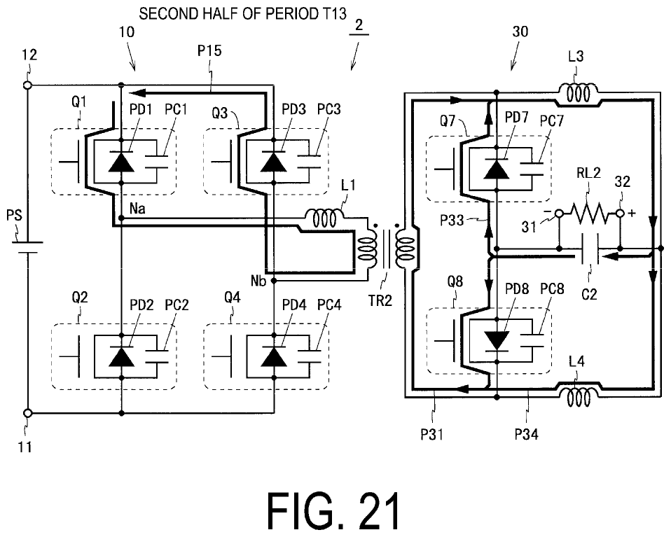

Before the current I2L4 becomes 0, the MOSFET Q7 is turned on, and the second half of the period T13 begins. FIG. 21 is a current path diagram of the second half of the period T13. In the primary circuit 10, the current continues to return through the path P15 described above. At this time, the current I1 is substantially constant. In the secondary circuit 30, soon after the MOSFET Q7 is turned on, the current I2L4 becomes negative (the orientation of the current I2L4 is reversed). At this time, the current flows through the paths P31, P33 described above; and a path P34 passing through the coil L4 after the coil L3 in the path P31. The currents I2L3, I2L4 continue to decrease and the current I2, which is the sum of the currents I2L3, I2L4, eventually becomes negative (the orientation of the current I2 is reversed). At this time, the capacitor C2 starts discharging.

The MOSFET Q1 is turned off at the start of the period T14, and the MOSFET Q8 is turned off in the middle of the period T14. In the period T14, the MOSFETs Q3, Q7 are in an on state, and the MOSFETs Q1, Q2, Q4 are in an off state. The MOSFET Q8 is in an on state until the middle of the period and subsequently in an off state. For the same reason as in the first reference example, the off operation of the MOSFET Q1 corresponds to zero voltage switching. As illustrated in FIG. 18, the period T14 is divided into the period T141 until the MOSFET Q8 starts the off operation, the period T142 until the current flowing through the MOSFET Q8 becomes 0, and the subsequent period T143.

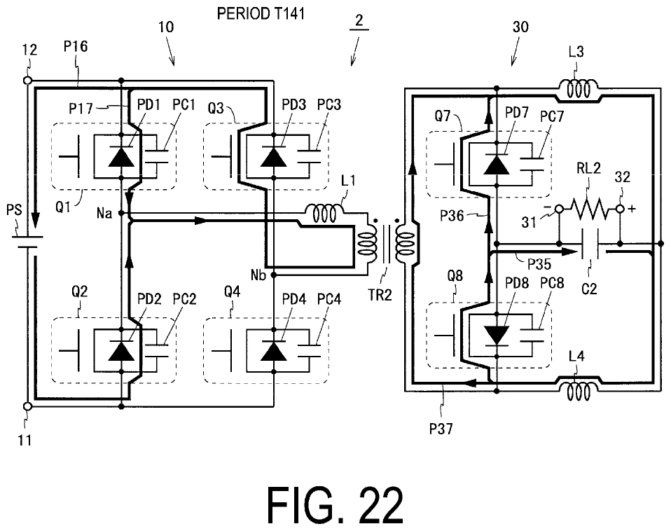

FIG. 22 is a current path diagram of the period T141. In the primary circuit 10, the current flows through the paths P16, P17 described above. At this time, the parasitic capacitor PC1 is charged, and the parasitic capacitor PC2 is discharged. Thus, the potential (and the voltage VQ2SD) of the node Na is reduced. In the period T141, the current flows toward the second input terminal 12, which is a positive input terminal. To make the current flow, the power stored in the coil L1 is used. Thus, the current I1 rapidly decreases and eventually becomes zero. In the secondary circuit 30, the current flows through a path P35 sequentially passing through the second output terminal 32, the coil L4, the MOSFET Q8, and the first output terminal 31; a path P36 sequentially passing through the MOSFET Q7 after the MOSFET Q8, and the coil L3; and a path P37 sequentially passing through the secondary winding of the transformer TR2 after the coil L4 and the coil L3. At this time, the capacitor C2 starts discharging.

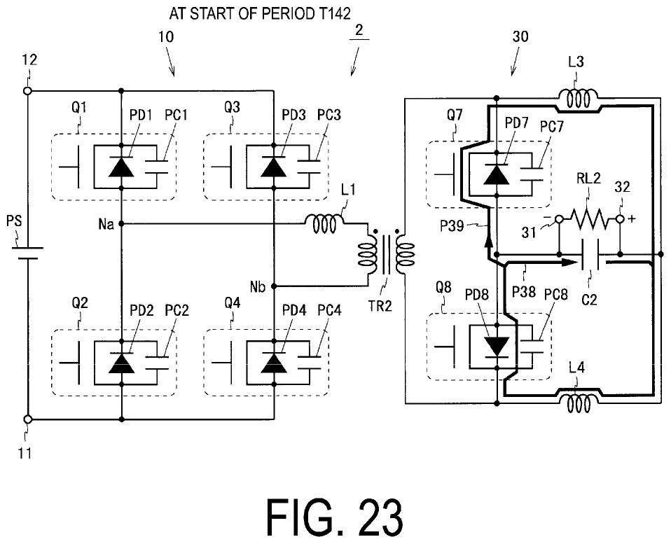

FIG. 23 is a current path diagram of the start of the period T142 (the moment MOSFET Q8 is turned off). At this time, current does not flow in the primary circuit 10. In the secondary circuit 30, the current flows through a path P38 sequentially passing through the second output terminal 32, the coil L4, a parasitic capacitor PC8, and the first output terminal 31; and a path P39 sequentially passing through the MOSFET Q7 after the parasitic capacitor PC8 and the coil L3. At this time, the parasitic capacitor PC8 is charged. The current I1 is zero, and thus the current I2T is also zero. However, here, the excitation current flowing through the transformer TR2 is ignored. In the period T142, as the parasitic capacitor PC8 is charged, the current flowing through the parasitic capacitor PC8 decreases and approaches 0. As a result, the current I2T begins to flow. This induces a voltage in the primary winding of the transformer TR2, and the current I1 increases once again.

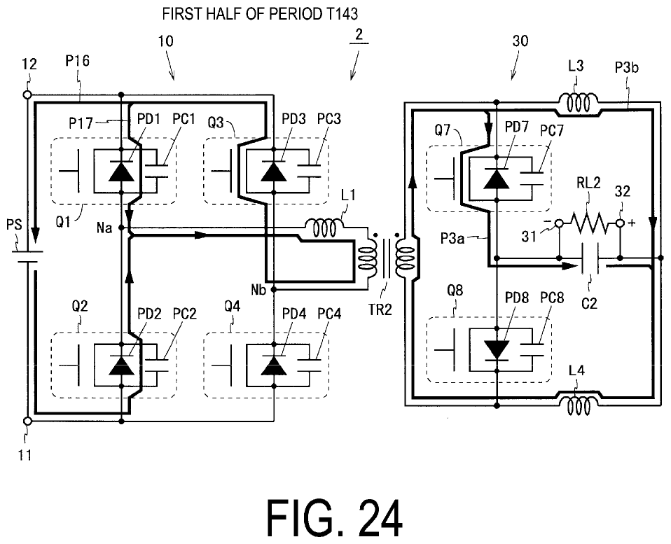

Similar to the first reference example, the current path in the primary circuit 10 changes in the middle of the period T143. FIG. 24 is a current path diagram of the first half of the period T143. In the primary circuit 10, the current flows once again through the same paths as those in the period T141 (paths P16, P17 described above). As a result, the charging of the parasitic capacitor PC1 and the discharging of the parasitic capacitor PC2 are resumed. Thus, the potential of the node Na (and the voltage VQ2SD) is reduced once again. In the secondary circuit 20, the current flows through a path P3a passing sequentially through the second output terminal 32, the coil L4, the secondary winding of the transformer TR2, the MOSFET Q7, and the first output terminal 31; and a path P3b flowing through the coil L3 after the secondary winding of the transformer TR2.

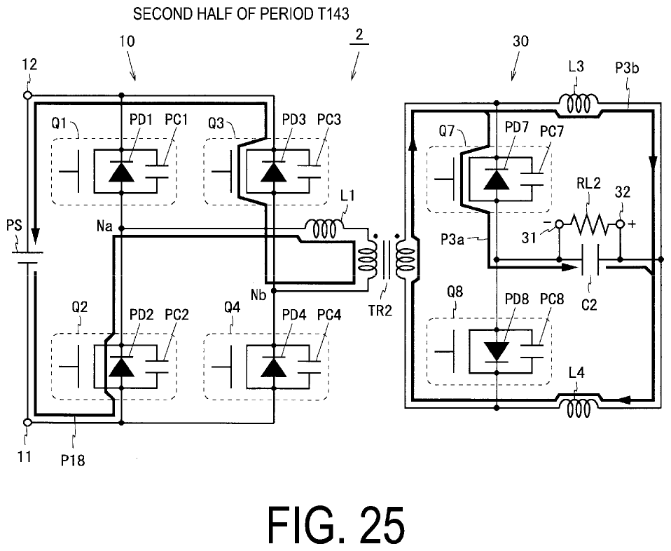

When the voltage VQ2SD becomes substantially zero, the second half of the period T143 begins. FIG. 25 is a current path diagram of the second half of the period T143. In the primary circuit 10, the current flows through the path P18 described above. In the secondary circuit 30, the current continues to flow through the paths P3a to P3b described above.

In this way, in the period T14, the capacitor C2 is discharged. Further, in the secondary circuit 30, the discharge current of the capacitor C2 flows from the second end toward the first end of the secondary winding of the transformer TR2, inducing voltage in the primary winding of the transformer TR2. As a result, in the primary circuit 10, the current I1 flows in a direction that makes the voltage VQ2SD zero.

At the start of the period T15, the MOSFET Q2 is turned on. For the same reason as in the first reference example, the on operation of the MOSFET Q2 corresponds to zero voltage switching. Note that in a case that the MOSFET Q8 is not turned off in the middle of the period T14 (that is, in a case that no discharge current of the capacitor C2 flows from the second end toward the first end of the secondary winding of the transformer TR2), the voltage VQ2SD and the current I1 respectively change as indicated by the dot-dash lines W3, W4 in FIG. 18. The on operation of the MOSFET Q2 in this state does not correspond to zero voltage switching.

In the periods T15 to T18, the power supply 2 operates symmetrically with the periods T11 to T14. Specifically, the operations of the MOSFETs Q1 to Q4, Q7, Q8 in the periods T15 to T18 are the same as the operations of the MOSFETs Q3, Q4, Q1, Q2, Q8, Q7 in the periods T11 to T14, respectively. The changes in the currents I2L3, I2L4 in the periods T15 to T18 are the same as the changes in the currents I2L4, I2L3 in the periods T11 to T14. The changes in the current I1 in the periods T15 to T18 are opposite to the changes in the current I1 in the periods T11 to T14 (absolute values are the same; positive and negative values are reversed).

In the power supply 2, before the MOSFET Q2 is turned on, the capacitor C2 starts discharging. In the period T141, the current flows through the path P35 passing through the coil L4 and the MOSFET Q8 and the like, from a positive electrode terminal (terminal on the right side in the drawing) toward a negative electrode terminal (terminal on the left side in the drawing) of the capacitor C2 (refer to FIG. 22). At the start of period T142, when the MOSFET Q8 is turned off, the current flows through the path P3a passing through the coil L4, the secondary winding of the transformer TR2, and the MOSFET Q7 (refer to FIG. 24). As a result, the current flows from the second end toward the first end of the secondary winding of the transformer TR2, voltage is induced in the primary winding of the transformer TR2, and the current I1 flows. The flow of the current I1 reduces the voltage VQ2SD.

The switching loss can be reduced by turning the MOSFET Q2 on after the voltage VQ2SD is reduced. In particular, the switching loss can be reduced by turning the MOSFET Q2 on after the voltage VQ2SD is reduced to substantially 0. Thus, in the power supply 2, the power stored in the capacitor C2 of the secondary circuit 30 is transmitted to the primary circuit 10, and the MOSFET Q2 is turned on after reducing the source-drain voltage of the MOSFET Q2. As a result, the switching loss can be reduced at the on operation of the MOSFET Q2. The power supply 2, using this same method, provides the reduced switching loss at the on operation of the MOSFETs Q1, Q3, Q4.

### Second Embodiment

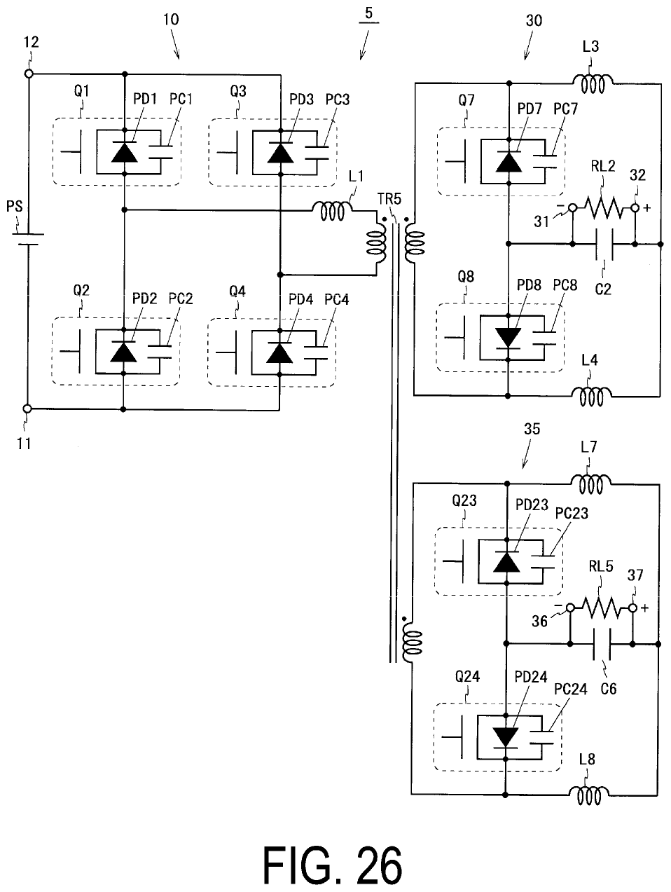

FIG. 26 is a circuit diagram of a power supply according to a second embodiment. A power supply 5 illustrated in FIG. 26 is a DC/DC converter including MOSFETs Q1 to Q4, Q7, Q8, Q23, Q24, a transformer TRS, coils L1, L3, L4, L7, L8, and capacitors C2, C6. The power supply 5 includes the primary circuit 10 on a primary side of the transformer TR5 and secondary circuits 30, 35 on a secondary side of the transformer TR5. The power supply 5 is configured by adding the secondary circuit 35 to the power supply 2 according to the second reference example and includes the plurality of secondary circuits 30, 35. For each of the secondary circuits 30, 35, a rated output voltage and a rated output current can be set. Note that the power supply 5 may include three or more secondary circuits.

The secondary circuit 35 has the same configuration as that of the secondary circuit 30. The secondary circuit 35 includes the MOSFETs Q23, Q24, the coils L7, L8, and the capacitor C6. The secondary circuit 35 includes a first output terminal 36 as a negative output terminal and a second output terminal 37 as a positive output terminal. The MOSFETs Q23, Q24 respectively include parasitic diodes PD23, PD24 and parasitic capacitors PC23, PC24. A load RL5 is connected between the first and second output terminals 36, 37. The transformer TR5 includes two secondary windings. The secondary circuits 30, 35 share the transformer TR5 and are respectively supplied with power from the two secondary windings of the transformer TR5.

Hereinafter, a case in which the output power of the secondary circuit 30 is less than the output power of the secondary circuit 35 will be described. In this case, without special ingenuity, the output voltage of the secondary circuit 30 may rise more than necessary (excessive rise in output voltage). In the power supply 5, to prevent an excessive rise in output voltage, the primary circuit 10 and the secondary circuit 30 operate in the same manner as in the second reference example. As a result, power is transmitted from the secondary circuit 30 to the primary circuit 10 and the secondary circuit 35, and thus the output voltage of the secondary circuit 30 can be reduced to the rated output voltage.

In the power supply 5, whether the power is transmitted to the primary circuit 10 or the secondary circuit 35 is determined by the power required to change the current flowing through the coil included in the circuit of the transmission destination. In particular, in a case that the power required to change the current flowing through the coil L1 is less than the power required to change the current flowing through the coils L7, L8, the power is transmitted to the primary circuit 10. Otherwise, the power is transmitted to the secondary circuit 35. Note that the current required to change the current flowing through the coil is determined by the inductance of the coil; and the like.

The voltage optimization operation performed by the secondary circuit 30 can also be regarded as a power regeneration operation in which the secondary circuit 30 transmits power to the primary circuit 10 or the secondary circuit 35. Further, the voltage optimization operation performed by the secondary circuit 30 can also be regarded as a discharge operation in which the capacitor C2 is discharged, causing current to flow through the secondary winding of the transformer TRS. The secondary circuit 30 may perform the voltage optimization operation in a case that the measured value of the output voltage is below a reference value and may perform the voltage optimization operation in a case that the measured value of the output voltage is above a reference value.

Conversely to the above-described case, in a case that the output power of the secondary circuit 35 is less than the output power of the secondary circuit 30, to prevent an excessive rise in output voltage of the secondary circuit 35, the secondary circuits 30, 35 may respectively perform the operations of the secondary circuits 35, 30 described above.

As described above, in the power supply 5 according to the present embodiment, at least one of the rectifier circuits (the secondary circuit 30) includes the first and second switching elements (MOSFETs Q7, Q8) as rectifier elements; and the first and second coils L3, L4. In at least one of the rectifier circuits, the first end (left end in the drawing) of the capacitor C2 is connected to the first end (upper end in the drawing) of the secondary winding of the transformer TR2 with the first switching element (MOSFET Q7) therebetween and is connected to the second end (lower end in the drawing) of the secondary winding with the second switching element (MOSFET Q8) therebetween, and the second end (right end in the drawing) of the capacitor C2 is connected to the first end of the secondary winding with the first coil L3 therebetween and is connected to the second end of the secondary winding with the second coil L4 therebetween. At least one of the rectifier circuits performs, as a discharge operation, an operation of making a current flow into the path P35 passing through the second switching element and the second coil L4 to start discharge of the capacitor C2; and an operation of subsequently turning off the second switching element to cause a current to flow into the path P3a passing through the second coil L4, the secondary windings, and the first switching element.

Thus, in the rectifier circuit having the configuration described above, a current is made to flow through the path P35 passing through the second switching element and the second coil to start discharge of the capacitor C2, and subsequently the second switching element is turned off, making it possible to cause a current to flow into the secondary winding of the transformer TR5 and to transmit power from the rectifier circuit to the switching circuit (primary circuit 10) or the other rectifier circuit (secondary circuit 35). Further, the rectifier circuit can be configured such that current flows into a path passing only through one rectifier element (the MOSFET Q7 or Q8) between the transformer TR5 and the capacitor C2, reducing a pass-through loss. Accordingly, it is possible to provide a power supply capable of stably outputting a plurality of voltages and having a high power-conversion efficiency.

The power supply 5 according to the present embodiment can constitute the following modified example. In the power supply 5, the primary circuit 10 is a full-bridge circuit, and the secondary circuits 30, 35 are current doubler circuits. In the power supply according to the modified example, the primary circuit and the secondary circuit may both be full-bridge circuits. In the power supply according to the modified example, one of the primary circuit and the secondary circuit operates as the switching circuit, and the other operates as the rectifier circuit. A bi-directional DC/DC converter can be configured by replacing both functions as necessary.

### Third Reference Example

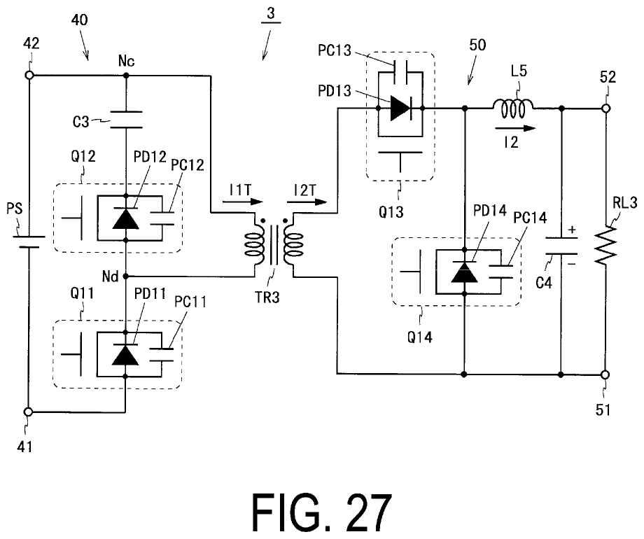

FIG. 27 is a circuit diagram of a power supply according to a third reference example. A power supply 3 illustrated in FIG. 27 is a DC/DC converter including N-channel type MOSFETs Q11 to Q14, a transformer TR3, a coil L5, and capacitors C3, C4. The MOSFETs Q11 to Q14 respectively include parasitic diodes PD11 to PD14 and parasitic capacitors PC11 to PC14. Note that in a case that the electrostatic capacitance of the parasitic capacitors PC11 to PC14 is insufficient, a capacitor may be externally connected in parallel to the parasitic capacitors PC11 to PC14.

The power supply 3 includes a primary circuit 40 on a primary side of the transformer TR3 and a secondary circuit 50 on a secondary side of the transformer TR3. The primary circuit 40 includes a first input terminal 41 as a negative input terminal and a second input terminal 42 as a positive input terminal. The secondary circuit 50 includes a first output terminal 51 as a negative output terminal and a second output terminal 52 as a positive output terminal. The direct current power supply PS is connected between the first and second input terminals 41, 42, and a load RL3 is connected between the first and second output terminals 51, 52.

The MOSFETs Q11 to Q14 are switching elements similar to the MOSFETs Q1 to Q8. The primary circuit 40 includes the MOSFETs Q11, Q12 and the capacitor C3. The secondary circuit 50 includes the MOSFETs Q13, Q14, the coil L5, and the capacitor C4.

In the primary circuit 40, a first end (upper end in the drawing) of the primary winding of the transformer TR3 and a first end (upper end in the drawing) of the capacitor C3 are connected to the second input terminal 42. A source electrode of the MOSFET Q11 is connected to the first input terminal 41, and a drain electrode of the MOSFET Q11 is connected to the source electrode of the MOSFET Q12 and to a second end of the primary winding of the transformer TR3. A drain electrode of the MOSFET Q12 is connected to a second end of the capacitor C3. Hereinafter, a node where a first end of the transformer TR3 is connected is referred to as Nc, a node where the second end of the transformer TR3 is connected is referred to as Nd, and potentials of the nodes Nc, Nd are referred to as Vc, Vd, respectively.

In the secondary circuit 50, the capacitor C4 is connected between the first and second output terminals 51, 52. A source electrode of the MOSFET Q13 is connected to a first end (upper end in the drawing) of the secondary winding of the transformer TR3, and a drain electrode of the MOSFET Q13 is connected to a drain electrode of the MOSFET Q14 and a first end (left end in the drawing) of the coil L5. A second end of the coil L5 is connected to the second output terminal 52. A source electrode of the MOSFET Q14 and a second end of the secondary winding of the transformer TR3 are connected to the first output terminal 51.

In this way, the primary circuit 40 is a switching circuit connected to the primary winding of the transformer TR3. This switching circuit is a forward circuit. The secondary circuit 50 is a rectifier circuit connected to the secondary winding of the transformer TR3. This rectifier circuit is a forward circuit. In the secondary circuit 50, a first end (upper end in the drawing) of the capacitor C4 is connected to the first end of the secondary winding of the transformer TR3 with the coil L5 and the MOSFET Q13 therebetween and is connected to the second end of the secondary winding of the transformer TR3 with the coil L5 and the MOSFET Q14 therebetween. A second end of the capacitor C4 is connected to the second end of the secondary winding of the transformer TR3. Both the MOSFETs Q13, Q14 are rectifier elements that rectify the power transmitted from the primary side of the transformer TR3, and the capacitor C3 stores the rectified power.

For the coil L5, a coil having an inductance of from 10 to 100 μH, for example, is used. For the capacitor C3, a capacitor having a capacitance of from 0.01 to 10 μF, for example, is used, and for the capacitor C4, a capacitor having a capacitance of from 20 to 1,000 μF, for example, is used. The inductance of the coil L5 and the capacitance of the capacitors C3, C4 may be values outside the ranges described above.

In the primary circuit 40, the MOSFET Q11 performs a switching operation. In this way, the direct current supplied from the direct current power supply PS is intermittently supplied to the primary winding of the transformer TR3. The MOSFET Q12 and capacitor C3 function as a circuit for resetting the power resulting from the excitation current of the transformer TR3. The transformer TR3 transforms the voltage supplied to the primary winding and outputs the voltage from the secondary winding. In the secondary circuit 50, the transformed alternating current supplied from the secondary winding of the transformer TR3 is rectified, and the capacitor C4 is charged. In this way, the power supply 3 converts the voltage level of the power supplied from the direct current power supply PS and supplies the power in the converted voltage to the load RL3.

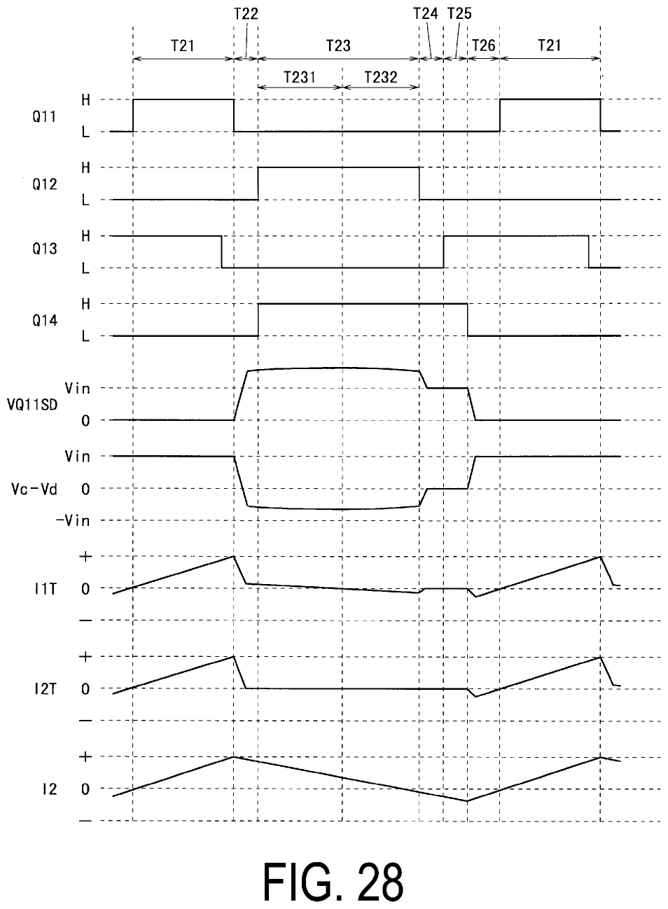

The operation of the power supply 3 in a case that the output power is relatively small will now be described with reference to FIG. 28 to FIG. 35. FIG. 28 is a timing chart of the power supply 3 in a case that the output power is relatively small. FIG. 28 illustrates changes in the gate potential of the MOSFETs Q11 to Q14, a source-drain voltage VQ11SD of the MOSFET Q11, a potential difference (Vc−Vd) between the nodes Nc, Nd, the current I1T flowing through the primary winding of the transformer TR3, the current I2T flowing through the secondary winding of the transformer TR3, and the current I2 flowing through the coil L5. In a case that the current flowing through the load RL3 is negligible, the current I2 is equal to the current flowing through the capacitor C4. The positive orientations of the currents I1T, I2T, I2 are as described in FIG. 27. One cycle of operation of the power supply 3 is divided into six periods T21 to T26, and the period T23 is further divided into two periods T231, T232.

As illustrated in FIG. 28, the MOSFET Q13 is turned off in the middle of the period T21. Hereinafter, the period until the MOSFET Q13 is turned off is referred to as a first half of the period T21, and the subsequent period is referred to as a second half of the period T21. In the period T21, the MOSFET Q11 is in an on state, and the MOSFETs Q12, Q14 are in an off state. The MOSFET Q13 is in an on state in the first half of the period T21 and an off state in the second half of the period T21.

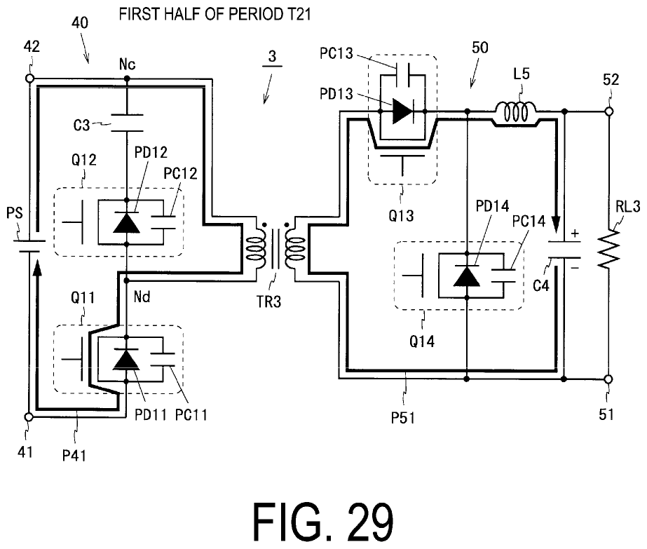

FIG. 29 is a current path diagram of the first half of the period T21. In the primary circuit 40, the current sequentially flows through a path P41 passing sequentially through the second input terminal 42, the primary winding of the transformer TR3, the MOSFET Q11, and the first input terminal 41. The current I1T increases over time. In the secondary circuit 50, voltage is induced in the secondary winding of the transformer TR3. The current flows through a path P51 sequentially passing through the first end of the secondary winding of the transformer TR3, the MOSFET Q13, the coil L5, the capacitor C4, and the second end of the secondary winding of the transformer TR3. At this time, the capacitor C4 is charged. In the first half of the period T21, power is transmitted from the primary circuit 40 to the secondary circuit 50.

At the start of the second half of the period T21, the MOSFET Q13 is turned off. In the second half of the period 21, in the primary circuit 40, the current continues to flow through the path P41 described above. In the secondary circuit 50, the current flows through a path (not illustrated) sequentially passing through the first end of the secondary winding of the transformer TR3, the parasitic diode PD13, the coil L5, the capacitor C4, and the second end of the secondary winding of the transformer TR3.

At the start of the period T22, the MOSFET Q11 is turned off. In the period T22, the MOSFETs Q11 to Q14 are in an off state. Since the MOSFET Q11 includes a parasitic capacitor PC11, the source-drain voltage of the MOSFET Q11 hardly rises when the MOSFET Q11 is turned off. Thus, the off operation of the MOSFET Q11 corresponds to zero voltage switching.

In the period T22, since the MOSFET Q11 is in the off state, the potential of the node Nd rises, and the current I1T decreases. In the current I1T, only an excitation current remains. The secondary winding of the transformer TR3 loses an electromotive force, and the current I2T becomes 0. Due to the excitation current, the voltage (Vc−Vd) across the primary winding of the transformer TR3 is negative, and the voltage VQ11SD exceeds the input voltage Vin. In the secondary circuit 50, the current starts to flow through a path (not illustrated) sequentially passing through the parasitic diode PD14, the coil L5, and the capacitor C4. Further, the current I2 also starts to decrease. Note that, while the necessary excitation current is clearly indicated in the description of the operation of the power supply 3 in the present reference example, the excitation current is ignored in the other reference examples.

At the start of the period T23, the MOSFETs Q12, Q14 are turned on. In the period T23, the MOSFETs Q12, Q14 are in an on state, and the MOSFETs Q11, Q13 are in an off state. Note that the timings at which the MOSFETs Q12, Q14 are turned on need not necessarily be the same.

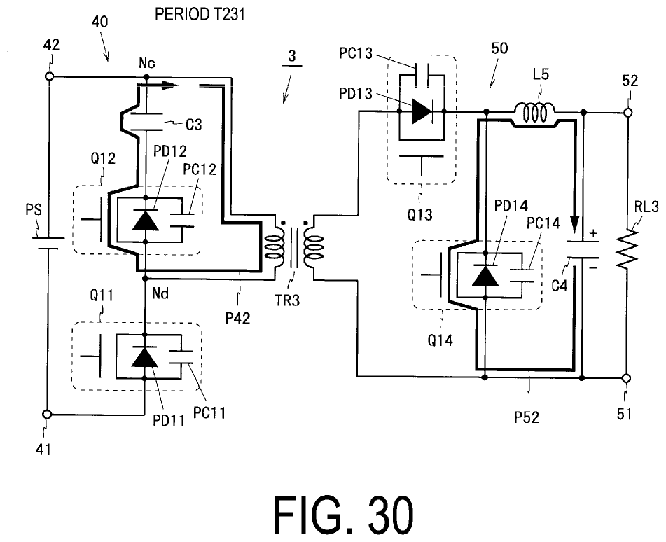

FIG. 30 is a current path diagram of the period T231. In the primary circuit 40, excitation current flows in the primary winding of the transformer TR3. The excitation current flows through a path P42 sequentially passing through the second end of the primary winding of the transformer TR3, the MOSFET Q12, the capacitor C3, and the first end of the primary winding of the transformer TR3. At this time, the capacitor C3 is charged, and the current I1T is gradually decreased. In the secondary circuit 50, due to the action of the coil L5 that stored power in the period T21, the current flows through a path P52 sequentially passing through the coil L5, the capacitor C4, and the MOSFET Q14. The current I2 is reduced by the action of the voltage across the capacitor C4.

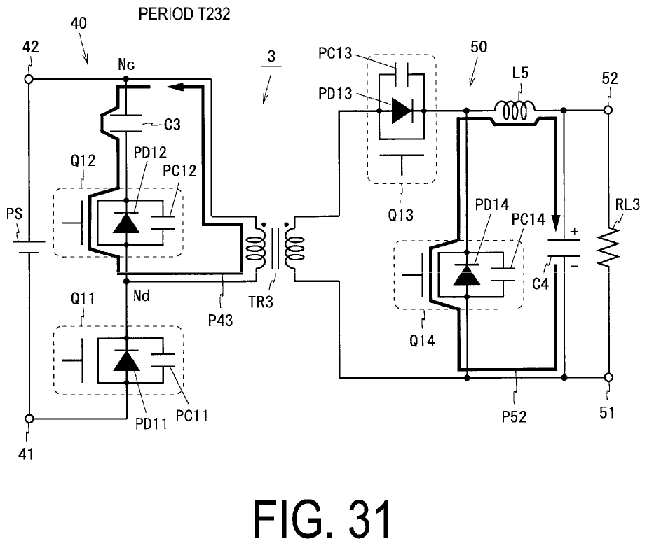

When the current I1T becomes 0, the period T232 begins (refer to FIG. 28). FIG. 31 is a current path diagram of the period T232. In the primary circuit 40, the current flows through a path P43 sequentially passing through the first end of the primary winding of the transformer TR3, the capacitor C3, the MOSFET Q12, and the second end of the primary winding of the transformer TR3. At this time, the capacitor C3 is discharged, and the power resulting from the excitation current of the transformer TR3 is reset. In the secondary circuit 50, the current continues to flow through the path P52 described above. The current I2 continues to decrease, and eventually becomes negative (the orientation of the current I2 is reversed). At this time, the capacitor C4 starts discharging.

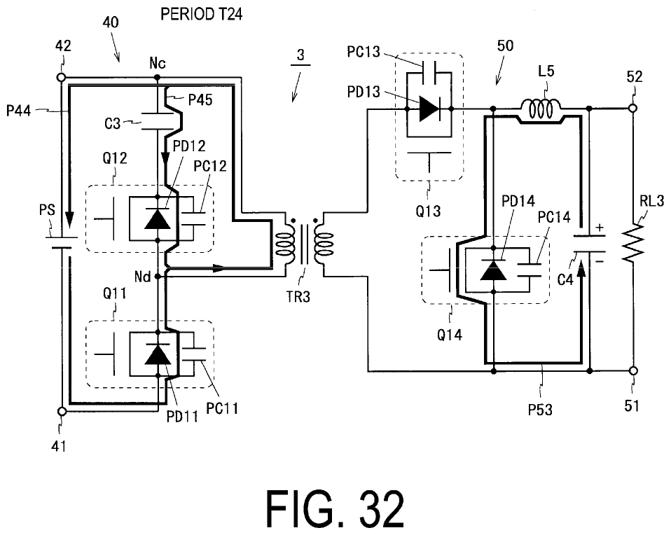

At the start of the period T24, the MOSFET Q12 is turned off. In the period T24, the MOSFETs Q11 to Q13 are in an off state, and the MOSFET Q14 is in an on state. FIG. 32 is a current path diagram of the period T24. In the primary circuit 40, the MOSFET Q12 is in the off state, and thus discharge of the capacitor C3 is inhibited. As a result, the potential of the node Nd is reduced. The current flows through a path P44 passing sequentially through the first input terminal 41, the parasitic capacitor PC11, the primary winding of the transformer TR3, and the secondary input terminal 42; and a path P45 sequentially passing through the capacitor C3, after the primary winding of the transformer TR3, and the parasitic capacitor PC12. At this time, the parasitic capacitor PC11 is discharged, and the parasitic capacitor PC12 is charged. In the secondary circuit 50, due to the action of the voltage across the capacitor C4, the current flows through a path P53 sequentially passing through the coil L5, the MOSFET Q14, and the capacitor C4.

In a case that the output power of the power supply 3 is relatively large, an on-duty ratio of the transformer TR3 is large, and the excitation current is also large. Thus, the potential of the node Nd in the period T231 is high, the voltage across the capacitor C3 is high, and the absolute value of the current I1T when the capacitor C3 is discharged during the period T232 is large. Thus, due to the action of the leakage inductance of the primary winding of the transformer TR3, the potential of the node Nd decreases to zero, and the voltage VQ11SD becomes 0. Thus, the on operation of the MOSFET Q11 corresponds to zero voltage switching. On the other hand, in a case that the output power of the power supply 3 is relatively small, the excitation current is small, and thus it is not possible to reduce the voltage at the node Nd to zero. In a case that the output power of the power supply 3 is small, the potential of the node Nd is only reduced to the input voltage Vin (refer to FIG. 28). Here, in the power supply 3, to make the on operation of the MOSFET Q11 correspond to zero voltage switching, the MOSFET Q14 is turned off at the start of the period T26. As a result, as described below, the capacitor C4 can be discharged to cause current to flow into the secondary winding of the transformer TR3, and the power stored in the capacitor C4 can be transmitted to the primary circuit 40 via the transformer TR1.

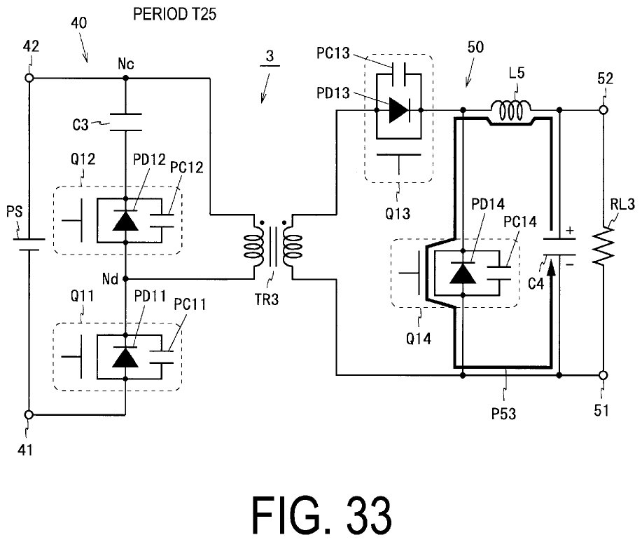

At the start of the period T25, the MOSFET Q13 is turned on. In the period T25, the MOSFETs Q11, Q12 are in an off state, and the MOSFETs Q13, Q14 are in an on state. FIG. 33 is a current path diagram of the period T25. In the primary circuit 40, because the potential of the node Nd is equal to the input voltage Vin, no current flows. In the secondary circuit 50, the current continues to flow through the path P53 described above.

At the start of the period T26, the MOSFET Q14 is turned off. In the period T26, the MOSFETs Q11, Q12, Q14 are in an off state, and the MOSFET Q13 is in an on state. The current path in the primary circuit 40 changes in the middle of the period T26. Hereinafter, the period until the current path changes is referred to as a first half of the period T26, and the subsequent period is referred to as a second half of the period T26.

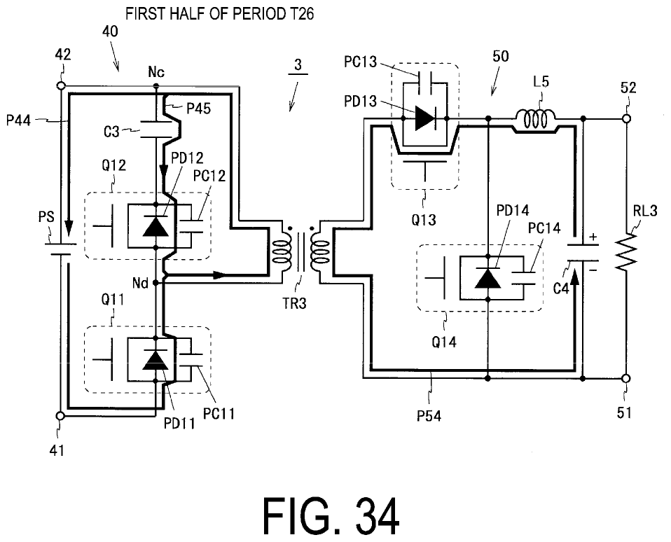

FIG. 34 is a current path diagram of the first half of the period T26. In the primary circuit 40, the current flows once again through the same paths as those in the period T24 (paths P44, P45 described above). As a result, the discharging of the parasitic capacitor PC11 and the charging of the parasitic capacitor PC12 are resumed. Thus, the potential (and the voltage VQ11SD) of the node Nd is reduced once again. In the secondary circuit 50, the current flows through a path P54 sequentially passing through the coil L5, the MOSFET Q13, the secondary winding of the transformer TR3, and the capacitor C4. Because the current flows from the first end to the second end of the secondary winding of the transformer TR3, an electromotive force is generated in the primary winding of the transformer TR3. Thus, the current begins to flow once again from the second end toward the first end of the primary winding of the transformer TR3.

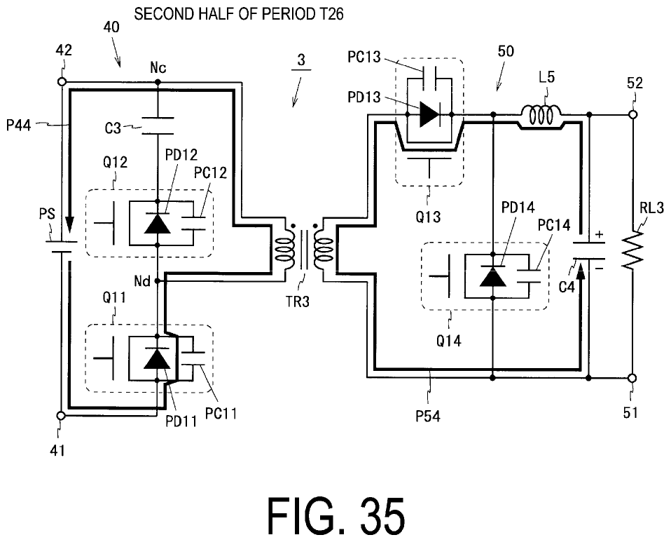

When the voltage VQ11SD becomes substantially zero, the second half of the period T26 begins. FIG. 35 is a current path diagram of the second half of the period T26. In the primary circuit 40, the current flows through the path P44 described above. In the secondary circuit 50, the current continues to flow through the path P54 described above.

In this way, in the periods T24 to T26, the capacitor C4 is discharged. Further, the discharge current of the capacitor C4 flows from the first end toward the second end of the secondary winding of the transformer TR3 via the coil L5, inducing voltage in the primary winding of the transformer TR3. As a result, the current I1T flows in a direction that sets the voltage VQ11SD to zero.

At the start of the next period T21, the MOSFET Q11 is turned on. At the start of the next period T21, the voltage VQ11SD is substantially zero, and a forward current is flowing through the parasitic diode PD11. Thus, the on operation of the MOSFET Q11 corresponds to zero voltage switching.

In the next period T21, in the primary circuit 40, the current flows from the first end to the second end of the primary winding of the transformer TR3 (in the direction opposite to that in the period T26). In the secondary circuit 50, the current flows from the second end to the first end of the secondary winding of the transformer TR3 (in the direction opposite to that in the period T26).

In the power supply 3, before the MOSFET Q11 is turned on, the capacitor C4 starts discharging. In the period T24, the current flows through a path P53 passing through the coil L5 and the MOSFET Q14, from a positive electrode terminal (terminal on the upper side in the drawing) toward a negative electrode terminal (terminal on the lower side in the drawing) of the capacitor C4. When the MOSFET Q14 is turned off at the start of period T26, the current flowing through the MOSFET Q14 is blocked, causing the current to flow through the path P54 passing through the coil L5, the MOSFET Q13, and the secondary winding of the transformer TR3 (refer to FIG. 34). As a result, the current flows from the first end to the second end of the secondary winding of the transformer TR3, voltage is induced in the primary winding of the transformer TR3, and the current I1T flows. The flow of the current I1T reduces the voltage VQ11SD.

The switching loss can be reduced by turning the MOSFET Q11 on after the voltage VQ11SD is reduced. In particular, the switching loss can be reduced by turning the MOSFET Q11 on after the voltage VQ11SD is reduced to substantially 0. Thus, the power supply 3 transmits the power stored in the capacitor C4 of the secondary circuit 50 to the primary circuit 40 and turns on the MOSFET Q11 after the source-drain voltage of the MOSFET Q11 is reduced. As a result, the switching loss can be reduced at the on operation of the MOSFET Q11.

### Third Embodiment

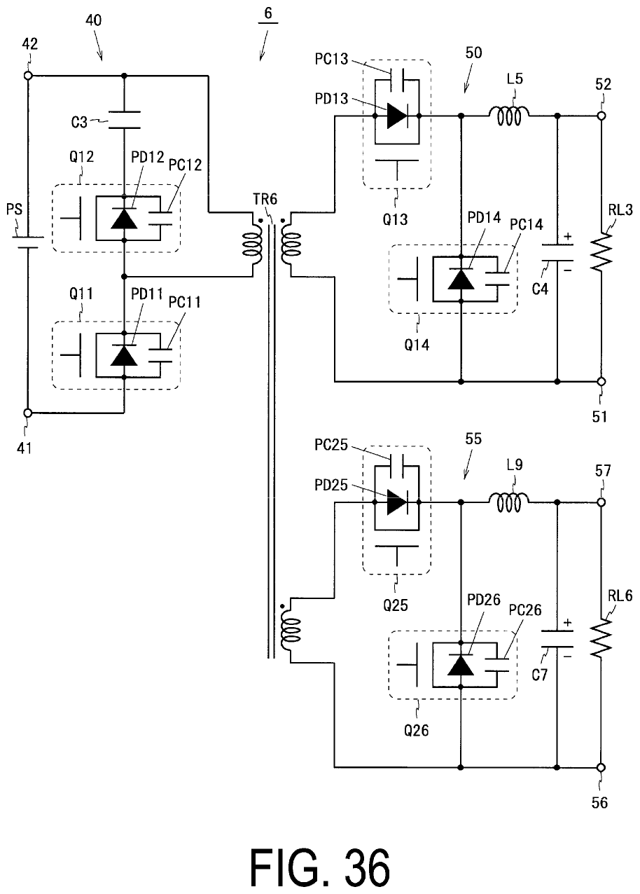

FIG. 36 is a circuit diagram of a power supply according to a third embodiment. A power supply 6 illustrated in FIG. 36 is a DC/DC converter including MOSFETs Q11 to Q14, Q25, Q26, a transformer TR6, coils L5, L9, and capacitors C3, C4, C7. The power supply 6 includes the primary circuit 40 on a primary side of the transformer TR6 and secondary circuits 50, 55 on a secondary side of the transformer TR6. The power supply 6 is configured by adding the secondary circuit 55 to the power supply 3 according to the third reference example and includes the plurality of secondary circuits 50, 55. For each of the secondary circuits 50, 55, a rated output voltage and a rated output current can be set. Note that the power supply 6 may include three or more secondary circuits.

The secondary circuit 55 has the same configuration as that of the secondary circuit 50. The secondary circuit 55 includes the MOSFETs Q25, Q26, the capacitor C7, and the coil L9. The secondary circuit 55 includes a first output terminal 56 as a negative output terminal and a second output terminal 57 as a positive output terminal. The MOSFETs Q25, Q26 respectively include parasitic diodes PD25, PD26 and parasitic capacitors PC25, PC26. A load RL6 is connected between the first and second output terminals 56, 57. The transformer TR6 includes two secondary windings. The secondary circuits 50, 55 share the transformer TR6 and are respectively supplied with power from the two secondary windings of the transformer TR6.

Hereinafter, a case in which the output power of the secondary circuit 50 is less than the output power of the secondary circuit 55 will be described. In this case, without special ingenuity, the output voltage of the secondary circuit 50 may rise more than necessary (excessive rise in output voltage). In the power supply 6, to prevent an excessive rise in output voltage, the primary circuit 40 and the secondary circuit 50 operate in the same manner as in the third reference example. As a result, power is transmitted from the secondary circuit 50 to the primary circuit 40 and the secondary circuit 55, and thus the output voltage of the secondary circuit 50 can be reduced to the rated output voltage.

In the power supply 6, power is preferentially transmitted to the secondary circuit 55. In a case that the power is large, the power is transmitted to both the primary circuit 40 and the secondary circuit 55. The reason for this is the same as in the first embodiment.

The voltage optimization operation performed by the secondary circuit 50 can also be regarded as a power regeneration operation in which the secondary circuit 50 transmits power to the primary circuit 40 or the secondary circuit 55. Further, the voltage optimization operation performed by the secondary circuit 50 can also be regarded as a discharge operation in which the capacitor C4 is discharged, causing current to flow into the secondary winding of the transformer TR6. The secondary circuit 50 may perform the voltage optimization operation in a case that the measured value of the output voltage is below a reference value and may perform the voltage optimization operation in a case that the measured value of the output voltage is above a reference value.

Conversely to the above-described case, in a case that the output power of the secondary circuit 55 is less than the output power of the secondary circuit 50, to prevent an excessive rise in output voltage of the secondary circuit 55, the secondary circuits 50, 55 may respectively perform the operations of the secondary circuits 55, 50 described above.

As described above, in the power supply 6 according to the present embodiment, at least one of the rectifier circuits (secondary circuit 50) includes the first and second switching elements (MOSFETs Q13, Q14) as rectifier elements; and the coil L5. In at least one of the rectifier circuits, the first end (upper end in the drawing) of the capacitor C4 is connected to the first end (upper end in the drawing) of the secondary winding of the transformer TR6 with the coil L5 and the first switching element (MOSFET Q13) therebetween and is connected to the second end (lower end in the drawing) of the secondary winding with the coil L5 and the second switching element (MOSFET Q14) therebetween. The second end (lower end in the drawing) of the capacitor C4 is connected to the second end of the secondary winding. At least one of the rectifier circuits performs, as a discharge operation, an operation of causing a current to flow into the path P53 passing through the coil L5 and the second switching element to start discharge of the capacitor C4; and an operation of subsequently turning the second switching element off to cause a current to flow into the path P54 passing through the coil L5, the first switching element, and the secondary winding.

Thus, according to the power supply 6 according to the present embodiment, in the rectifier circuit having the configuration described above, a current is made to flow through the path P53 passing through the coil L5 and the second switching element to start discharge of the capacitor, and subsequently the second switching element is turned off, making it possible to cause a current to flow into the secondary winding of the transformer TR6 and to transmit power from the rectifier circuit to the switching circuit (primary circuit 40) or the other rectifier circuit (secondary circuit 55). Accordingly, it is possible to provide a power supply capable of stably outputting a plurality of voltages.

Further, because the switching circuit (primary circuit 40) is a forward circuit, it is possible to provide a power supply that includes a forward circuit as the switching circuit and is capable of stably outputting a plurality of voltages.

### Fourth Embodiment

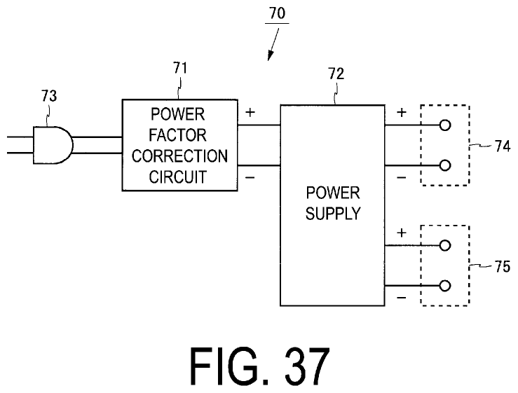

FIG. 37 is a circuit diagram of a power supply unit according to a fourth embodiment. A power supply unit 70 illustrated in FIG. 37 includes a power factor correction circuit 71, a power supply 72, an alternating current (AC) plug 73, and output terminals 74, 75. The power supply 72 is any one of the power supplies according to the first to third embodiments and the modified examples thereof.

The power factor correction circuit 71 performs control so that the input voltage and input current are substantially proportional and suppresses the generation of harmonics. The power factor correction circuit 71 outputs 400 V direct current voltage in a case that an alternating voltage of from 100 to 240 V is input, for example. The power supply 72 converts the direct current voltage output from the power factor correction circuit 71 to a direct current voltage of a desired level. The power supply unit 70 can be used as an AC adapter or a power supply built into an electric device.

As described above, the power supply unit 70 according to the present embodiment includes any one of the power supplies according to the first to third embodiments and the modified examples thereof. Thus, according to the power supply unit 70 according to the present embodiment, it is possible to provide a power supply unit capable of stably outputting a plurality of voltages.

Note that the power supply having the features of the plurality of embodiments and the modified examples may be configured by any combination of the features of the power supplies according to the first to third embodiments and the modified examples thereof as long as the nature of the power supply is not adversely affected.

As described above, a power supply may include a transformer including a primary winding and a plurality of secondary windings, a switching circuit connected to the primary winding, and a plurality of rectifier circuits connected to the plurality of secondary windings, respectively. At least one of the plurality of rectifier circuits may be configured to perform a power regeneration operation of transmitting power to the switching circuit or another rectifier circuit of the plurality of rectifier circuits (first aspect).

At least one of the plurality of rectifier circuits may include a rectifier element configured to rectify the power transmitted from a primary side of the transformer, may include a capacitor configured to store the power that is rectified, and be configured to perform a discharge operation of discharging the capacitor and causing a current to flow into a secondary winding of the plurality of secondary windings of the transformer (second aspect).

At least one of the plurality of rectifier circuits may include a first switching element and a second switching element as the rectifier element and further include a coil. At least one of the plurality of secondary windings may include a center tap. In at least one of the plurality of rectifier circuits, a first end of the capacitor may be connected to a first end of a secondary winding of the plurality of secondary windings with the first switching element between the first end of the capacitor and the first end of the second winding and may be connected to a second end of the secondary winding with the second switching element between the first end of the capacitor and the second end of the secondary winding, and a second end of the capacitor may be connected to the center tap with the coil between the second end of the capacitor and the center tap. At least one of the plurality of rectifier circuits may, as the discharge operation, be configured to cause a current to flow into a path passing through the coil, the center tap, the first end of the secondary winding, and the first switching element; and into a path passing through the coil, the center tap, the second end of the secondary winding, and the second switching element to start discharge of the capacitor and then to turn off the second switching element (third aspect).

At least one of the plurality of rectifier circuits may include a first switching element and a second switching element as the rectifier element and further include a first coil and a second coil. In at least one of the plurality of rectifier circuits, a first end of the capacitor may be connected to a first end of a secondary winding of the plurality of secondary windings with the first switching element between the first end of the capacitor and the first end of the secondary winding and may be connected to a second end of the secondary winding with the second switching element between the first end of the capacitor and the second end of the secondary winding, and a second end of the capacitor may be connected to the first end of the secondary winding with the first coil between the second end of the capacitor and the first end of the secondary winding and may be connected to the second end of the secondary winding with the second coil between the second end of the capacitor and the second end of the secondary winding. At least one of the plurality of rectifier circuits may, as the discharge operation, be configured to cause a current to flow into a path passing through the second coil and the second switching element to start discharge of the capacitor and subsequently to turn off the second switching element to cause a current to flow into a path passing through the second coil, the secondary winding, and the first switching element (fourth aspect).

At least one of the plurality of rectifier circuits may include a first switching element and a second switching element as the rectifier element and further include a coil. In at least one of the plurality of rectifier circuits, a first end of the capacitor may be connected to a first end of a secondary winding of the plurality of secondary windings with the coil and the first switching element between the first end of the capacitor and the first end of the secondary winding and may be connected to a second end of the secondary winding with the coil and the second switching element between the first end of the capacitor and the second end of the secondary winding, and a second end of the capacitor may be connected to the second end of the secondary winding. At least one of the plurality of rectifier circuits may, as the discharge operation, be configured to cause a current to flow into a path passing through the coil and the second switching element to start discharge of the capacitor and subsequently to turn off the second switching element to cause a current to flow into a path passing through the coil, the first switching element, and the secondary winding (fifth aspect).

The switching circuit may be a full-bridge circuit (sixth aspect). The switching circuit may be a forward circuit (seventh aspect). A power supply unit may include the power supply according to any of the first to seventh aspects (eighth aspect).

According to the first aspect, the rectifier circuit having a small output power performs a power regeneration operation, causing power to be transmitted from the rectifier circuit having a small output power to the switching circuit or another rectifier circuit. This makes it possible to prevent an excessive increase in output voltage in the rectifier circuit having a small output power. Accordingly, it is possible to provide a power supply capable of stably outputting a plurality of voltages.

According to the second aspect, the rectifier circuit having a small output power performs the discharge operation of discharging the capacitor and causing a current to flow into the secondary winding of the transformer, transmitting power from the rectifier circuit having a small output power to the switching circuit or another rectifier circuit. This makes it possible to prevent an excessive increase in output voltage in the rectifier circuit having a small output power. Accordingly, it is possible to provide a power supply capable of stably outputting a plurality of voltages.

According to the third aspect, in the rectifier circuit having the configuration described above, a current is made to flow through the two paths to start discharge of the capacitor, and subsequently the second switching element is turned off, making it possible to cause a current to flow into the secondary winding of the transformer and to transmit power from the rectifier circuit to the switching circuit or another rectifier circuit. Further, the rectifier circuit can be configured so that the current flows into a path passing through only one rectifier element between the transformer and the capacitor, reducing a pass-through loss. Accordingly, it is possible to provide a power supply capable of stably outputting a plurality of voltages and having a high power-conversion efficiency.

According to the fourth aspect, in the rectifier circuit having the configuration described above, a current is made to flow into a path passing through the second switching element and the second coil to start discharge of the capacitor, and subsequently the second switching element is turned off, making it possible to cause a current to flow into the secondary winding of the transformer and to transmit power from the rectifier circuit to the switching circuit or another rectifier circuit. Further, the rectifier circuit can be configured so that the current flows into a path passing through only one rectifier element between the transformer and the capacitor, reducing a pass-through loss. Accordingly, it is possible to provide a power supply capable of stably outputting a plurality of voltages and having a high power-conversion efficiency.

According to the fifth aspect, in the rectifier circuit having the configuration described above, a current is made to flow through a path passing through the coil and the second switching element to start discharge of the capacitor, and subsequently the second switching element is turned off, making it possible to cause a current to flow into the secondary winding of the transformer and to transmit power from the rectifier circuit to the switching circuit or another rectifier circuit. Accordingly, it is possible to provide a power supply capable of stably outputting a plurality of voltages.

According to the sixth aspect, it is possible to provide a power supply that includes a full-bridge circuit as the switching circuit and is capable of stably outputting a plurality of voltages. According to the seventh aspect, it is possible to provide a power supply that includes a forward circuit as the switching circuit and is capable of stably outputting a plurality of voltages. According to the eighth aspect, it is possible to provide a power supply unit capable of stably outputting a plurality of voltages.

This application claims the benefit of priority to Japanese Patent Application Number 2017-31950 entitled “Power Supply and Power Supply Unit” filed on Feb. 23, 2017. The entire contents of the above-identified application are hereby incorporated by reference.

### REFERENCE SIGNS LIST

4, 5, 6 Power supply

10, 15, 40 Primary circuit

20, 25, 30, 35, 50, 55 Secondary circuit

11, 41 First input terminal

12, 42 Second input terminal

21, 26, 31, 36, 51, 56 First output terminal

22, 27, 32, 37, 52, 57 Second output terminal

70 Power supply unit

71 Power factor correction circuit

72 Power supply

73 AC plug

74 Output terminal

1. A power supply comprising:
a transformer including a primary winding and a plurality of secondary windings;
a switching circuit connected to the primary winding; and
a plurality of rectifier circuits connected to the plurality of secondary windings, respectively,
wherein at least one of the plurality of rectifier circuits is configured to perform a power regeneration operation of transmitting power to the switching circuit or another rectifier circuit of the plurality of rectifier circuits.

2. The power supply according to claim 1,
wherein at least one of the plurality of rectifier circuits
includes a rectifier element configured to rectify the power transmitted from a primary side of the transformer and a capacitor configured to accumulate the power that is rectified and
is configured to perform a discharge operation of discharging the capacitor and causing a current to flow into a secondary winding of the plurality of secondary windings of the transformer.

3. The power supply according to claim 2,
wherein at least one of the plurality of rectifier circuits includes a first switching element and a second switching element as the rectifier element and further includes a coil,
at least one of the plurality of secondary windings includes a center tap,
in at least one of the plurality of rectifier circuits, a first end of the capacitor is connected to a first end of a secondary winding of the plurality of secondary windings with the first switching element between the first end of the capacitor and the first end of the secondary winding and is connected to a second end of the secondary winding with the second switching element between the first end of the capacitor and the second end of the secondary winding, and a second end of the capacitor is connected to the center tap with the coil between the second end of capacitor and the center tap, and
at least one of the plurality of rectifier circuits, as the discharge operation, is configured to cause a current to flow into a path passing through the coil, the center tap, the first end of the secondary winding, and the first switching element and into a path passing through the coil, the center tap, the second end of the secondary winding, and the second switching element to start discharge of the capacitor and then to turn off the second switching element.

4. The power supply according to claim 2,
wherein at least one of the plurality of rectifier circuits includes a first switching element and a second switching element as the rectifier element and further includes a first coil and a second coil,
in at least one of the plurality of rectifier circuits, a first end of the capacitor is connected to a first end of a secondary winding of the plurality of secondary windings with the first switching element between the first end of the capacitor and the first end of the secondary winding and is connected to a second end of the secondary winding with the second switching element between the first end of the capacitor and the second end of the secondary winding, and a second end of the capacitor is connected to the first end of the secondary winding with the first coil between the second end of the capacitor and the first end of the secondary winding and is connected to the second end of the secondary winding with the second coil between the second end of the capacitor and the second end of secondary winding, and
at least one of the plurality of rectifier circuits, as the discharge operation, is configured to cause a current to flow into a path passing through the second coil and the secondary switching element to start discharge of the capacitor and subsequently to turn off the second switching element to cause a current to flow into a path passing through the second coil, the secondary winding, and the first switching element.

5. The power supply according to claim 2,
wherein at least one of the plurality of rectifier circuits includes a first switching element and a second switching element as the rectifier element and further includes a coil,
in at least one of the plurality of rectifier circuits, a first end of the capacitor is connected to a first end of a secondary winding of the plurality of secondary windings with the coil and the first switching element between the first end of the capacitor and the first end of the secondary winding and is connected to a second end of the secondary winding with the coil and the second switching element between the first end of the capacitor and the second end of the secondary winding, and a second end of the capacitor is connected to the second end of the secondary winding, and
at least one of the plurality of rectifier circuits, as the discharge operation, is configured to cause a current to flow into a path passing through the coil and the second switching element to start discharge of the capacitor and subsequently to turn off the second switching element to cause a current to flow into a path passing through the coil, the first switching element, and the secondary winding.

6. The power supply according to claim 1,
wherein the switching circuit is a full-bridge circuit.

7. The power supply according to claim 1,
wherein the switching circuit is a forward circuit.

8. A power supply unit comprising:
the power supply according to claim 1.

9. A power supply unit comprising:
the power supply according to claim 2.

10. A power supply unit comprising:
the power supply according to claim 3.

11. A power supply unit comprising:
the power supply according to claim 4.

12. A power supply unit comprising:
the power supply according to claim 5.

13. A power supply unit comprising:
the power supply according to claim 6.

14. A power supply unit comprising:
the power supply according to claim 7.
